(19) United States
(12) Patent Application Publication
(10) Pub. No.: US 2025/0097286 A1
(43) Pub. Date: Mar. 20, 2025

(54) ASSISTING LOCAL SERVICE MANAGEMENT ON EDGE TERMINAL DEVICES

(71) Applicant: CONVIDA WIRELESS, LLC, Wilmington, DE (US)

(72) Inventors: Xu ` LI, Plainsboro, NJ (US); Dale SEED, Allentown, PA (US); Lu LIU, Conshohocken, PA (US)

(21) Appl. No.: 18/703,909

(22) PCT Filed: Nov. 2, 2022
(86) PCT No.: PCT/US2022/079104

§ 371 Date: Apr. 23, 2024

Related U.S. Application Data
(60) Provisional application No. 63/274,679, filed on Nov. 2, 2021.

(51) Int. Cl. H04L 67/1008; H04L 67/2895

(52) U.S. Cl. CPC H04L 67/1008; H04L 67/2895

(57) ABSTRACT

Edge terminal service host that hosts a local service and initiates relocating this local service to another service host in the system. Relocation may occur when there is a determination that the local service has become overloaded.

### CROSS-REFERENCE TO RELATED APPLICATIONS

This application claims the benefit of U.S. Provisional Patent Application No. 63/274,679, filed on Nov. 2, 2021, entitled “Assisting Local Service Management On Edge Terminal Devices,” the contents of which are hereby incorporated by reference herein.

### BACKGROUND

Edge computing allows data produced by internet of things (IoT) devices to be processed closer to where it is created instead of sending it across long routes to data centers or clouds.

Edge computing deployments are ideal in a variety of circumstances. One is when IoT devices have poor connectivity and it's not efficient for IoT devices to be constantly connected to a central cloud. Other use cases have to do with latency-sensitive processing of information. Edge computing reduces latency because data does not have to traverse over a network to a data center or cloud for processing.

This background information is provided to reveal information believed by the applicant to be of possible relevance. No admission is necessarily intended, nor should be construed, that any of the preceding information constitutes prior art.

### SUMMARY

Various edge terminals (ET), such as a private user equipment (UE), a vehicle, or a roadside unit may function as a server host (SH) and directly provide various local services (LSs) by hosting corresponding LS-servers (LS-S). A LS is a service deployed on a terminal device and available locally and is not deployed on a centralized cloud server or edge server in the network. From a typical client-server implementation perspective, a LS-S is to provide server-side functionalities of the LS while the local service-clients (LS-Cs) may be hosted by other entities, and may access those LS-Ss by sending requests to LS-Ss hosted on those ETs (those edge terminals are denoted as ET-SHs). Various LS types include local group chatting service, local image sharing service, etc. In particular, the data may be directly processed by LS-Ss on ETs, instead of sending the data to the central cloud servers or edge servers in the network for storing, sharing, or processing.

Currently, there is no existing research focusing on the above scenario (e.g., LS-Ss may be directly hosted by ET-SHs). With this new paradigm, this work discloses a new service, which is called a local service assistant (LSA). In general, LSA 202 may support comprehensive LS management at the edge. For example, a number of new procedures are disclosed for a LSA such that the LSA may help various enabling operations such as LS provisioning, LS registration, LS discovery, LS quality of service (QoS) management via relocation, etc. In particular, the following procedures are disclosed.

A first procedure may be a service provisioning procedure between ET-SH and a configuration server (CS). For example, this procedure may allow ET-SH 201 to identify a desired nearby LSA. Procedures based on Request-Response as well as Subscription-Notification models are defined respectively.

A second procedure may be a service registration procedure between a LSA and a CS. For example, this procedure may allow LSA to register its information to a CS such that this LSA may be identified or discovered by nearby ET-SHs.

A third procedure may be a service registration procedure between ET-SH and an LSA. For example, this procedure may allow ET-SH to register to a desired/identified LSA after this LSA has been discovered by the ET-SH via a CS.

A fourth procedure includes a suite of LS discovery/advertisement procedures, which may allow LS-Cs to discover available nearby LSs.

A fifth procedure includes an advanced and distributed service discovery mechanism, which allows a client to discover a desired server of a particular service, which may be deployed in the cloud or on an edge infrastructure or hosted by an ET-SH.

The second focus of this disclosure is disclosing the approach of local service QoS management via service relocation. For example, different from a traditional cloud and/or edge service provider, ET-SHs may only have comparatively limited on-board computing/storage resources, thus on-demand service scalability may be a constraint. In the meantime, there may be nearby Edge Cloud Infrastructures (ECIs) that are available and usually have more powerful resources/capabilities. They are provided by edge computing resource providers or those ECIs are deployed in the 3GPP networks by the mobile operators (such as in the 5G edge network). Those ECIs are denoted as ECI-SHs. The following service relocation directions are considered herein.

A first scenario may be associated with on how edge computing infrastructure (e.g., the ECI-SHs) may help the ET-SHs for improving their local service flexibility or scalability, which is an essential QoS-related metric.

A second scenario may be associated with a reverse direction in the sense that some local services may originally be hosted on ECI-SHs and how ECI-SHs may relocate their LS-Ss 20 further down to the desired edge terminals (e.g., the ET-SHs) in order to achieve certain QoS performance, e.g., to further reduce the service delivery delay of their LSs.

New approaches are also disclosed for LSA, which may assist SHs (which are denoted as Source-SH, or S-SH) in relocating their LS-Ss to other desired SHs (which are denoted as Destination-SH, or D-SH). In particular, the following procedures are disclosed. A first procedure may be a SH-side-initiated LS relocation procedure, which allows a S-SH to initiate a LS-S relocation operation when certain trigger conditions (e.g., QoS metrics) are met. A second procedure may be a LSA-side-initiated LS relocation procedure, which allows a LSA to collect useful information and make intelligent decisions (on behalf of S-SHs) for proactively initiating LS-S relocation operations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary reference architecture of ETSI MEC;

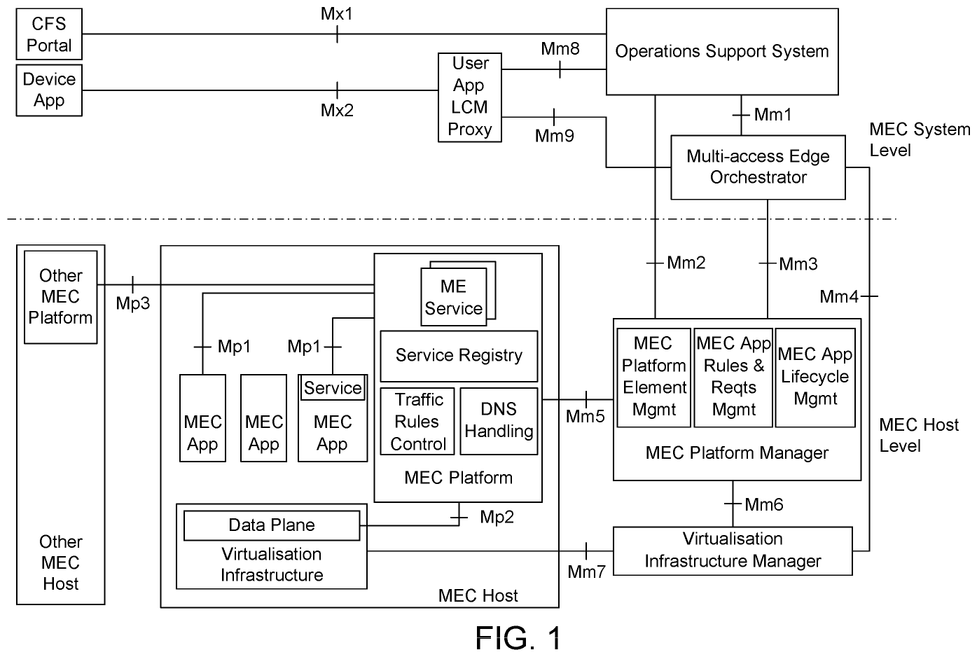

FIG. 2 illustrates exemplary local services provided in an Olympic Park;

FIG. 3 illustrates an exemplary architecture of the local service assistant (LSA);

FIG. 4 illustrates an exemplary procedure of service provisioning of ET-SH to a CS (Request-Response Model);

FIG. 5 illustrates an exemplary procedure of service provisioning of ET-SH to a CS (subscription-notification model);

FIG. 6 illustrates an exemplary service provisioning notification from ET-SH to a CS;

FIG. 7 illustrates an exemplary procedure of service registration of ET-SH to a LSA;

FIG. 8 illustrates an exemplary procedure of service registration of LSA to a CS;

FIG. 9 illustrates an exemplary procedure for local service discovery by LS-Cs;

FIG. 10 illustrates an exemplary procedure for advanced service discovery;

FIG. 11A illustrates an exemplary procedure for SH-side-Initiated LS Relocation;

FIG. 11B is a continuation of exemplary procedure for SH-side-Initiated LS Relocation in FIG. 11A;

FIG. 12A illustrates an exemplary procedure for LSA-side-Initiated LS Relocation;

FIG. 12B is a continuation of exemplary procedure for LSA-side-Initiated LS Relocation in FIG. 12A;

FIG. 13 illustrates an exemplary 3GPP SA6 embodiment of application architecture for enabling edge;

FIG. 14 illustrates an exemplary user interface;

FIG. 15A illustrates an example communications system;

FIG. 15B illustrates an exemplary system that includes RANs and core networks;

FIG. 15C illustrates an exemplary system that includes RANs and core networks;

FIG. 15D illustrates an exemplary system that includes RANs and core networks;

FIG. 15E illustrates another example communications system;

FIG. 15F is a block diagram of an example apparatus or device, such as a WTRU; and

FIG. 15G is a block diagram of an exemplary computing system.

### DETAILED DESCRIPTION

Multi-access Edge Computing (MEC) enables the implementation of MEC applications as software-only entities that run on top of a virtualization infrastructure, which is located in or close to the network edge. Technical standards for MEC are being developed by the European Telecommunications Standards Institute (ETSI), such as the reference architecture of ETSI MEC.

The multi-access edge system may include the MEC hosts and the MEC management necessary to run MEC applications within an operator network or a subset of an operator network.

The MEC host is an entity that includes a MEC platform and a virtualization infrastructure which provides compute, storage, or network resources, for the purpose of running MEC applications.

The MEC platform is the collection of essential functionality required to run MEC applications on a particular virtualization infrastructure and enable them to provide and consume MEC services. The MEC platform may also provide services.

MEC applications are instantiated on the virtualization infrastructure of the MEC host based on configuration or requests validated by the MEC management.

The MEC management may include the MEC system level management and the MEC host level management.

The MEC system level management may include the multi-access edge orchestrator as its core component, which has an overview of the complete MEC system.

The MEC host level management may include the MEC platform manager and the virtualization infrastructure manager and may handle the management of the MEC specific functionality of a particular MEC host and the applications running on it.

Within 3GPP, the Service Architecture Working Group 6 (SA6) is pushing the boundaries of 3GPP beyond the traditional system and radio standards. The 3GPP SA6 Working Group has gradually expanded its activities for the standardization of new vertical applications within the 3GPP ecosystem, and also promoting the adoption of 3GPP 5G technology across a variety of industries. In particular, some of the activities are related to how to adopt edge computing capabilities.

3GPP Rel-16 TS 23.434 specifies Service Enabler Architecture Layer (SEAL) services that may be reused across vertical applications. In particular, SEAL specifies northbound APIs to enable flexible integration with vertical applications. The features of SEAL services may include a common core service set such as group management, configuration management, location management, identity/key management, or network resource management. SEAL services are supported both in on-network and off-network (e.g., UE-to-UE communication) deployments. For example, when a SEAL server is deployed at the edge, a SEAL client on a UE may send its requests to the SEAL server for accessing certain services provided at the edge. A more detailed description of SEAL may be found in 3GPP Rel-16 TS 23.434.

The 3GPP SA6 EDGEAPP work item defines an application architecture for enabling edge applications over 3GPP networks. The aspects of this work include identifying architecture requirements (e.g., discovery of edge services, authentication of the clients), supporting an application layer functional model and corresponding approaches to enable the deployment of applications on the edge of 3GPP networks with minimal impact to edge-based applications on the UE. A more detailed description about this study may be found in 3GPP Rel-17 TS 23.558.

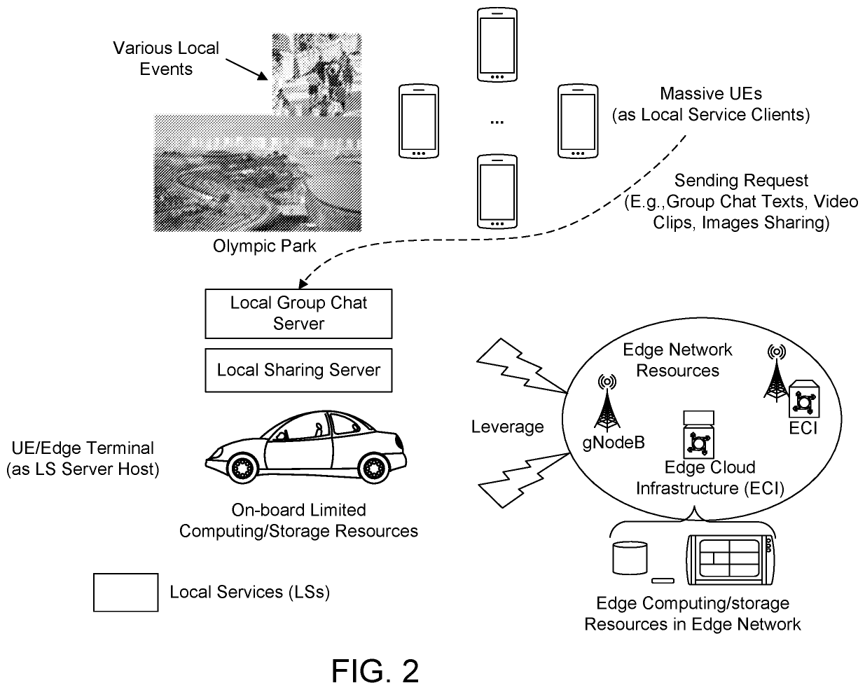

FIG. 2 illustrates exemplary local services provided in an Olympic park. A first issue may be related to enabling local service on edge terminals. For example, in an Olympic park, there may be frequent social events (e.g., award ceremonies or musical shows). Significant numbers of nearby UEs (e.g., smartphones) may attempt to communicate with each other for group chatting, image/video sharing, call-for-participation, or the like, which may lead to a large amount of data creation, processing, or sharing. In particular, those services may be provided as local services (LSs) on edge terminals, instead of sending the data to the central cloud or edge infrastructure node in the network for storing, sharing, or processing.

In particular, various edge terminals (ET), such as a private UE, a vehicle, or a roadside unit may function as a server host (SH) and directly provide various local services (LSs) by hosting corresponding LS-Servers (LS-S). A LS may be a service deployed or available locally (e.g., at the edge terminal) and may not be deployed on a centralized cloud or edge infrastructure node in the network. From a typical client-server implementation perspective, a LS-S is to provide server-side functionalities of the LS while the Local Service-Clients (LS-Cs), which may be hosted by other entities and may access those LS-Ss 205 by sending requests to LS-Ss 205 hosted on those edge terminals (those edge terminals are denoted as ET-SHs 201). Various LS types include local group chatting service, local image sharing service, etc. In particular, the data may be directly processed at the edge terminal, instead of sending the data to a cloud infrastructure node or edge infrastructure node in the network for storing, sharing, or processing.

However, there is no existing approaches that may support this new paradigm where LS-Ss 205 may be directly hosted by ET-SHs 201. In particular, in order to make the system work, a number of operations (such as LS provisioning, LS registration, LS discovery, etc.) may include approaches that are missing in conventional networks.

A second issue may be related to how to support LS QoS management via service relocation at the edge. Different from a traditional cloud service provider, ET-SHs 201 may only have limited on-board computing/storage resources, thus on-demand service scalability may be a constraint. In the meantime, there may be nearby edge computing infrastructures (ECIs) that are available and that have more powerful resources or capabilities. They may be provided by edge computing resource providers or the ECIs may be deployed in the 3GPP networks by the mobile operators (such as in the 5G edge network). The ECIs may be denoted as ECI-SHs. In particular, as disclosed, there are multiple service relocation direction scenarios considered and each of them have their own specific QoS objectives.

A first scenario may be is associated with how edge computing resources (e.g., the ECI-SHs) may help the ET-SHs 201 improve their local service flexibility or scalability.

A second scenario may be associated with a reverse direction in the sense that some local services may originally be hosted on ECI-SHs and how ECI-SHs may relocate their LS-Ss 205 further down to the desired edge terminals (e.g., the ET-SHs 201), which may improve QoS related to service delivery delay of their LSs.

There are a number of unique challenges associated with the aforementioned approaches targeted by this disclosure and there may be no existing approaches that may efficiently help an SH (e.g., ET-SH 201 or an ECI-SH 208) to leverage nearby resources for improving its service scalability (a QoS objective that the first scenario may focus on) or reducing the service delivery delay (another QoS objective that the second scenario may focus on).

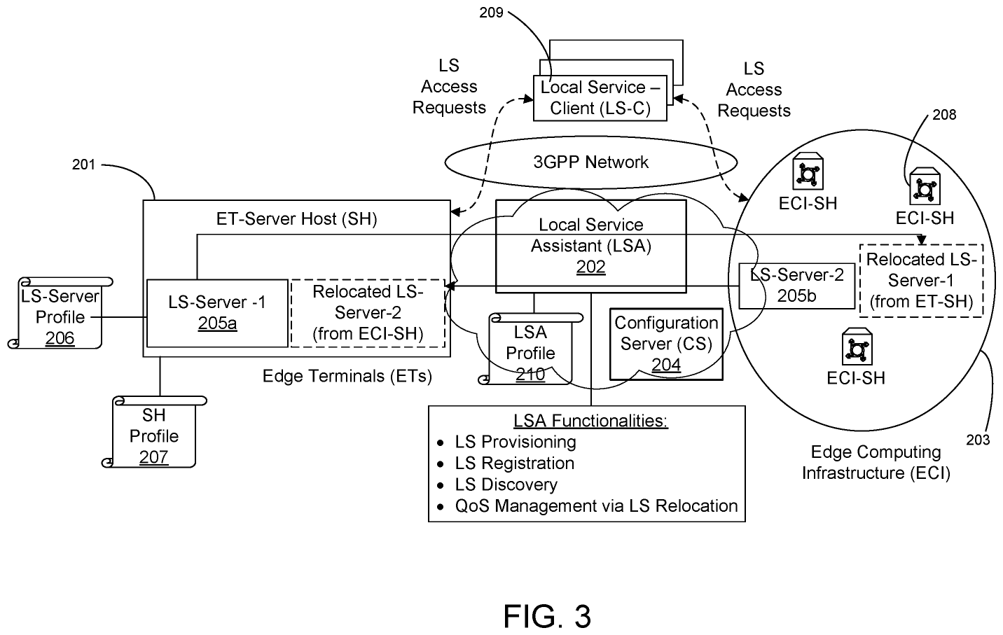

FIG. 3 illustrates an exemplary architecture associated with a local service assistant (LSA) 202. In general, LSA 202 support comprehensive LS management at the edge. For example, a number of procedures are disclosed for LSA 202 such that LSA 202 may be associated with various operations, such as LS provisioning, LS registration, LS discovery, or LS QoS management via relocation, among other things.

The disclosed procedures may realize local service management via the disclosed LSA. A first procedure may be a service provisioning procedure of ET-SH 201 to a configuration server (CS) 204. For example, this procedure may allow ET-SH 201 to identify a desired nearby LSA 202 in the nearby area. Procedures based on Request-Response as well as Subscription-Notification models are defined respectively. Note that, from an implementation perspective, the disclosed LSA 202 and CS 204 may be realized in the same physical entity (e.g., node). A second procedure may be a service registration procedure of LSA 202 to a CS 204. For example, this procedure may allow LSA 202 to register its information to CS 204 such that this LSA 202 may be identified or discovered by nearby ET-SHs 201. A third procedure may be a service registration procedure of ET-SH 201 to an LSA 202. For example, this procedure may allow ET-SH 201 to register to a desired/identified LSA 202 after this LSA 202 has been discovered by the ET-SH 201 via a CS 204. A fourth procedure may be a suite of LS discovery procedures or LS advertisement procedures, which may allow LS-Cs 209 to discover available nearby LSs. A fifth procedure may be an advanced and distributed service discovery mechanism, which may allow a client to discover a desired server of a particular service, which may be deployed in the cloud, by an edge infrastructure or by an ET-SH 201. A sixth procedure may be a SH-side-initiated LS relocation procedure, which may allow a S-SH to initiate a LS-S relocation operation when certain trigger conditions are met (e.g., to improve a specific QoS metric). A seventh procedure may be a LSA-side-initiated LS relocation procedure, which may allow LSA 202 to collect useful information and make intelligent decisions (on behalf of S-SHs) for proactively initiating LS-S relocation operations.

In the meantime, in order to describe the detailed information of the related entities, the following profiles are disclosed in this disclosure (and their detailed designs are described herein).

A LS-S Profile 206 describes the related information about a particular LS-S 205. A SH Profile 207 describes the related information about a particular SH (e.g., a ET-SH or a ECI-SH). A LSA Profile 210 describes the related information about a particular LSA 202.

For a given LS, its corresponding LS-S 205 may be initially deployed on ET-SH 201 (such as a UE or a vehicle) or deployed on an ECI-SH 208 (e.g., an edge computing infrastructure owned by the operator). Therefore, before introducing various new operations and procedures, a LS-S profile 206 is defined. In general, a LS-S profile 206 describes the information regarding a specific LS-S 205, which is summarized in the Table 1.

TABLE 1
Local Service-Server (LS-S) Profile

| Information element | Description |
|---|---|
| LS-S-ID | Identity of this particular LS-S. |

Information Elements of Corresponding LS of This LS-S

| | |
|---|---|
| Corresponding LS Type ID | This parameter indicates the corresponding LS type of |
| | this LS-S. For example, this LS-S is providing a local |
| | video sharing type of local service. Note that, for a given |
| | LS, it may be provided through one or more |
| | corresponding LS-Ss. |
| LS Description | This is to show a human readable service description for |
| | the LS. |

Information Elements of SHs that Can Host This LS-S

| | |
|---|---|
| SH Type | This parameter indicates which type of SH is desired to |
| | host this LS-S, e.g., a mobile UE, a roadside unit, or a |
| | vehicle, etc. |
| ID(s) of SH(s) currently | This parameter indicates which SH is currently hosting |
| hosting LS-S | this LS-S. |
| Mobility Type of the SH | This parameter indicates whether the SH currently |
| Currently Hosting LS-S | hosting LS-S is a fixed node (such as an edge computing |
| | facility) or a mobile node (e.g., a private UE, a private |
| | vehicle). This information element may include a link |
| | referring to the “SH Mobility Type” parameter in its own |
| | profile of the SH (as defined as SH Profile herein). |
| Mobility Profile of the SH | If an SH is a mobile type as indicated in the SH Mobility |
| Currently Hosting LS-S | Type parameter, this parameter is further to show the |
| | mobility profile of the SH that is currently hosting LS-S, |
| | e.g., a travel or moving schedule and trajectory |
| | information. This information element may include a link |
| | referring to the “Mobility Profile” parameter in. |

Information Elements of Basic Characteristic of LS-S

| | |
|---|---|
| LS-S Schedule | The expected operation schedule of this particular LS-S. |
| | For example, a video sharing LS-S may only be |
| | operated/available in a Olympic park during certain time |
| | period, e.g., when sport events are being held. |
| Service Radius | When a given LS-S is hosted by an ET-SH, e.g., a UE or |
| | a vehicle, this parameter is to indicate the service radius |
| | according to the current location of this specific ET-SH. |
| | For example, if LS-S-1 is currently hosted by mobile |
| | vehicle (e.g., vehicle-1) and has service radius of 500 |
| | meters, then the LS-Cs within 500 meters to the vehicle- |
| | 1 may access the LS-S-1. |
| Served Geographical Area | This parameter is present when Service Radius is not |
| | present. This is to show this LS-S is to cover which |
| | locations, and/or areas. For example, a given video |
| | sharing LS-S for a swimming match may only be |
| | available inside the aquatics of Olympic park. |
| LS-S Access | This parameter indicates a general accessing address |
| Address/endpoints | (such as URL) or endpoints for the LS-S. For example, |
| | when the LS-S of a LS is initially deployed on ET-SH |
| | (e.g., a vehicle, a UE or a road-side unit), the ET-SH |
| | needs to provide the access interface for this LS-S. |
| Expected Maximum or | This is to show how many LS-Cs may be served by this |
| Average LS-C volume | LS-S. For example, if a LS-S is deployed or hosted by an |
| | ET-SH, the LS-S may only serve limited number of LS- |
| | Cs since the LS-S may only get allocated with a limited |
| | amount of on-board computing resources. In addition, the |
| | volume may refer to the number of the LS-Cs or the total |
| | received requests during a given time period. |
| The Expected | This parameter indicates what is the expected |
| Performances of This LS-S | performance (KPIs) of this LS-S. For example, the |
| | performance data may include but not limited to: |
| | Minimum/Maximum/Average |
| | transactions/requests that may be processed |
| | by this LS-S per second |
| | The maximum processing time cost or delay of this LS-S |
| | Etc. |

Information Elements of Potential LS-Cs of This LS-S

| | |
|---|---|
| Access Criteria | This parameter indicates which kinds of entities may be |
| | the LS-Cs of this LS-S. For example, the criteria for |
| | granting access privilege may include: |
| | Whether it belongs to a specific organization. |
| | Whether it is within certain distance to the SH |
| | that hosts the LS-S. |
| | Whether it has already paid certain fee for |
| | enjoying the LS-S. |
| | Etc. |
| LS-S Access Priority | This parameter indicates whether a given type of LS-C |
| | has certain priority to accessing this LS-S. For example, |
| | when a LS-S is serving a high number of access requests, |
| | the requests from a VIP LS-C may be served while |
| | requests from lower-priority LS-Cs may get declined |
| | temporarily. |
| Currently served LS-Cs | This parameter indicates which LS-Cs are currently using |
| | this LS-S. This parameter is useful when the LS-S is |
| | being relocated to another SH such that those currently |
| | served LS-Cs may get notified. |

Information Elements Related to LS-S Discovery Mechanism by LS-Cs

| | |
|---|---|
| LS-S Discovery Approach | This parameter indicates how LS-Cs may discover this |
| | LS-S. The potential approaches include: |
| | Via LSA |
| | Via 3GPP network broadcasting |
| | Via pre-configuration |
| | Via Configuration Server |
| | Etc. |
| LS-S Discovery Radius | This parameter indicates the maximum distance between |
| | a LS-C and a LS-S such that the LS-C is able to discover |
| | this LS-S. For example, for a given LS-S-1, if LS-S-1 is |
| | currently hosted by mobile vehicle (e.g., vehicle-1) and |
| | has the discovery radius of 500 meters, then if a LS-C is |
| | within 500 meters to the vehicle-1, then it may discover |
| | LS-S-1. |

Information Elements Related to LS-S Relocation Trigger Conditions and Needs

| | |
|---|---|
| LS-S Service Relocation | This parameter indicates the general relocation needs |
| Needs | (e.g., criteria) for this LS-S. |
| > Desired geographical | When this LS-S needs to be relocated (from the Source- |
| location/area of the | SH), this parameter is to show the desired geographical |
| Destination-SH | location of the D-SH. For example, for a LS-S hosted by |
| | a vehicle (as S-SH) staying inside an Olympic park, it |
| | may want to be relocated to a nearby ECI-SH (as D-SH) |
| | have powerful resources, which is a ECI that is very |
| | close to the Olympic park. |
| > Desired Performance | This parameter indicates if the LS-S is being relocated, |
| provided by D-SH | what is the expected performance that the relocated LS-S |
| | hosted on D-SH needs to provide. For example, the |
| | performance data may include but not limited to: |
| | Minimum/Maximum/Average |
| | transactions/requests that may be supported |
| | by the relocated LS-S per second |
| | The maximum processing time cost or delay |
| | that may be supported by the relocated LS-S |
| | Minimum/Maximum/Average |
| | Computing/Storage/Memory Resources |
| | expected to be allocated to the relocated LS-S |
| | by the D-SH. |
| | Etc. |
| > Desired Running | This parameter indicates the running environment needed |
| Environment of LS-S | by the D-SH to run the relocated LS-S. For example |
| | requirements (e.g., criteria) related to software, |
| | framework, OS, etc. |
| Relocation Instructions | This parameter indicates the detailed instructions |
| | regarding how to relocate this LS-S. |
| >Downloadable LS-S | Sometimes it is necessary to re-install a new working |
| installation package | instance of the LS-S on the D-SH. Accordingly, this |
| | parameter is to show where the D-SH may download a |
| | LS-S installation package if D-SH does not have it. |
| >Who to Inform Currently | This parameter indicates who is responsible for |
| served LS-Cs | informing the currently served LS-Cs regarding the |
| | new/relocated LS-S. For example, S-SH or the D-SH |
| | may send notifications to the involved LS-Cs about the |
| | newly LS-S that is available on the D-SH. |
| >Relocation/Rollback | This parameter indicates when a relocation (e.g., relocate |
| Triggers/policies | a LS-S from S-SH to D-SH) or a relocation rollback |
| | (e.g., move an relocated LS-S from D-SH back to its S- |
| | SH) operation shall be triggered. For example, for a |
| | given LS-S X, the trigger conditions for relocation |
| | include but not limited to: |
| | A S-SH may initiate a relocation when LS-S |
| | X becomes overloaded. |
| | The number of requests reaches a certain |
| | upper threshold during a given time interval. |
| | The software instance of LS-S X has reached a certain |
| | level of utilization/loading (e.g., |
| | 90%). |
| | The processing time cost or the delivery delay |
| | for each of the requests targeted to LS-S X |
| | hosted on S-SH reaches a certain threshold |
| | The remaining energy of S-SH reaches a certain |
| | low threshold (For example, ET-SHs |
| | 201 only have the limited computing/storage |
| | as well as energy resources) |
| | The communication links between S-SH and |
| | its LS-Cs exceed a certain bandwidth |
| | utilization threshold or S-SH is too far from |
| | the targeted LS-Cs. |
| | Any other conditions observed by S-SH that |
| | trigger S-SH to start relocation. |
| | Alternatively, a LSA may automatically |
| | identify other needs (e.g., criteria) and trigger |
| | the relocations. |
| | The rollback trigger conditions may also be defined in a |
| | similar way. |
| >Relocation/Rollback | In addition to relying on relocation triggers, the |
| Schedule | relocation/rollback may also be initiated based on certain |
| | schedules, which may be indicated via this parameter. |
| | For example: |
| | Relocation Schedule: When to relocate the |
| | LS-S of a LS from a S-SH to a D-SH |
| | Relocation Rollback Schedule: When to move |
| | back the relocated LS-S from the D-SH back |
| | to the S-SH |

Information Elements Related to Current LS-S Relocation Status

| | |
|---|---|
| S-SH-ID | This parameter indicates this specific LS-S is originally |
| | deployed or hosted by which specific SH. This parameter |
| | stores the ID of the S-SH. |
| Relocation Status | This parameter indicates whether this LS-S is currently |
| | being relocated. If not, this LS-S is hosted by its S-SH |
| | (e.g., the SH where this LS-S is originally deployed). |
| D-SH-ID | If the relocation status indicates that this LS-S is |
| | currently being relocated, this parameter will be present |
| | and is to indicate the ID of the D-SH, e.g., where the LS- |
| | S is relocated. |

As an SH (e.g., ET-SH 201 or a ECI-SH 208), a SH profile is defined, which describes the information regarding a specific SH, which is summarized in the Table 2.

TABLE 2
Server Host (SH) Profile

| Information Element | Description |
|---|---|
| SH-ID | Identity of the SH. |
| SH Type | The category or type of SH, e.g., ET-SH |
| | 201 (such as a vehicle, a UE or a roadside |
| | unit), or an ECI-SH. In general, ET-SH |
| | 201 may have relatively limited |
| | capability/capacity compared to an ECI- |
| | SH. However, ET-SH 201 may have more |
| | mobility than an ECI-SH. In addition, ET- |
| | SH 201 may be owned by individual |
| | while an ECI-SH may be owned by |
| | commercial parties, such as operators, |
| | service providers, etc. |
| SH Affiliation | This parameter indicates whether the SH |
| | is private or owned by any organization, |
| | such as mobile operators, public |
| | transportation authority, etc.. |
| SH Mobility Type | This parameter indicates whether the SH |
| | is a fixed node (such as an edge |
| | computing facility) or a mobile node (e.g., |
| | a private UE, a private vehicle, a public |
| | bus/truck, etc.). |
| SH Mobility Profile | If a SH is a mobile type as indicated in the |
| | SH Mobility Type parameter, this |
| | parameter is further to show the mobility |
| | profile of a SH, e.g., a travel or moving |
| | schedule and trajectory information. |
| SH Work Schedule | This parameter indicates whether an SH |
| | have certain work schedule. Note that, a |
| | given SH's work schedule need to be |
| | carefully configured by considering the |
| | expected LS-S schedule of its hosted LS- |
| | Ss. In addition, this parameter may also be |
| | useful when evaluating when a LS-S |
| | should be relocated to this SH by |
| | comparing their respective availability |
| | schedule. |
| SH Resource Capabilities | This parameter describes the basic |
| | capabilities information of an SH, such as |
| | computing/storage/bandwidth/memory |
| | capability. |
| Current | This parameter indicates the current |
| Remaining/available | remaining/available |
| Resources | computing/storage/bandwidth/memory |
| | resources of this SH. This information is |
| | useful when evaluating whether this SH |
| | may accept/host a new relocated LS-S. |
| A List of LS-S Profile(s) | This parameter is to include the LS-S |
| | profiles of LS-Ss 205 that are currently |
| | hosted by this SH. |
| Accepted LS Type for | This parameter indicates which types of |
| Relocation | LS may be relocated to this SH. In other |
| | words, the corresponding LS-Ss 205 of |
| | those LS types may be relocated from |
| | their S-SHs to this SH (as a D-SH) when |
| | needed. |
| Other Specific Needs or | On one hand, each hosted LS-S may have |
| Requirement for LSAs | its relocation needs as described in the |
| | LS-S profile. On the other hand, from an |
| | SH perspective, it may also specify certain |
| | needs for LSA. For example, an SH may |
| | request to use a particular LSA that is |
| | affiliated with a particular operator, or a |
| | LSA that may help to relocate LS-Ss 205 |
| | to certain Edge Computing Infrastructure |
| | owned by a particular organization, or a |
| | LSA that is within the certain distance and |
| | is available during certain time intervals, |
| | etc.. |

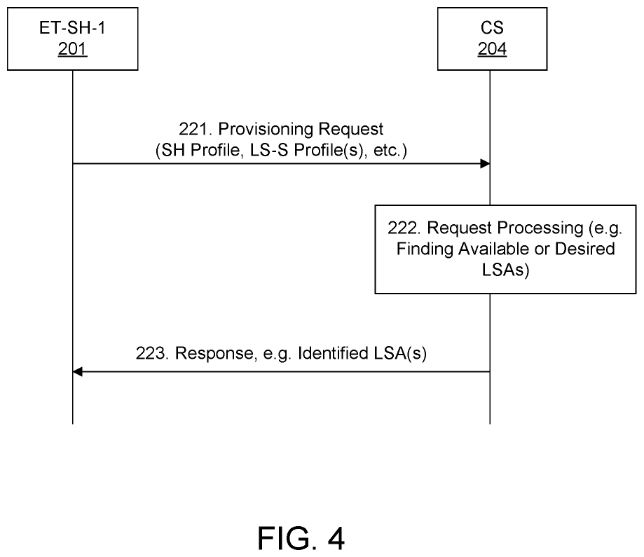

Procedure Design of Service Provisioning of ET-SH to a CS 204 (Request-Response Model): A configuration server (CS) 204 may be available in a given local area, which may provide discovery or configuration-related functionalities. One of the functions of CS 204 is to enable the discovery of various entities. For example, via a CS 204, ET-SH 201 may discover a nearby LSA 202. The reason is ET-SHs 201 are usually mobile or private edge terminals, such as UEs (e.g., vehicles or smartphone), so they have to frequently look for nearby LSAs 202 when they move to a new area (e.g., a threshold location). In comparison, an ECI-SH 208 may be a substantially fixed edge computing infrastructure, which may be owned by telecom operators and accordingly, it may not be necessary to rely on a CS 204 to discover available LSAs 202 (e.g., pre-provisioning and pre-configuration may be conducted). In order to facilitate ET-SH 201 to discover nearby LSAs 202, different entities may register their information to CS 204 such that they may be discovered by other entities. A service provisioning procedure based on a Request-Response model is disclosed which enables ET-SH 201 to discover a nearby LSA 202 based on a criteria, such as in FIG. 4 and the accompanying description.

Pre-condition: ET-SH 201 may be an edge terminal that hosts a number of local services, e.g., a number of LS-Ss. ET-SH 201 may move to a new area (Area-1) and based on its knowledge (e.g., via pre-configurations), ET-SH 201 knows there is a CS 204 in this area. Other than that, ET-SH 201 may not have any knowledge regarding whether there is any available LSA 202 that may provide help on LS management. On the other hand, in Area-1, there is an available LSA 202, which may help SHs (including both ET-SHs 201 and ECI-SHs 208) for LS management (e.g., to advertise a LS to potential LS-Cs 209, to help a LS to find a relocation host, etc.) and such a LSA 202 has already registered and shared its information with the CS 204 (based on a LSA registration to CS 204, which is defined herein).

With reference to step 221 of FIG. 4, ET-SH 201 may be hosting (e.g., running) a number of LS-Ss. Accordingly, ET-SH 201 may send a service provisioning request to CS 204 to request some basic information of the Area-1, e.g., whether there is an available LSA 202 in Area-1, etc. It is also possible that ET-SH 201 may send its own information (e.g., as described in the SH profile of ET-SH 201) as well as the detailed information of its hosted LS-Ss 205 (e.g., as described in the LS-S profiles 206) so that CS 204 may help to find a desired LSA 202 which may help ET-SH 201 for various LS management purposes (e.g., to advertise a LS to potential LS-Cs 209, to help a LS to find a relocation host, etc.). In this request, the following information may be carried:1) an SH profile of ET-SH 201 or 2) a list of LS-S profiles. The detailed information elements defined in the SH profile in Table 2 may be the parameters carried in this request. With regard to the list of LS-S profiles of the LSs hosted/deployed on ET-SH 201, the detailed information elements defined in the LS-S profiles 206 in Table 1 may be the parameters carried in this request. In addition, sometimes for the service provisioning purpose, it may not be necessary to include the information elements defined in LS-S profile 206.

Note that, in the LS-S profiles 206, they may describe the basic information about local services. In comparison, in the SH profile 207 of ET-SH 201, it may specify the basic information about the host itself.

At step 222 of FIG. 4, CS 204 may receive the service provisioning request, and determines ET-SH 201 has the right privilege and security credential. Then, CS 204 stores the detailed information about ET-SH 201. After that, CS 204 may identify whether there is an available LSA 202 in Area-1 based on the LSA registration information. In particular, if there are more than one LSA 202 in Area-1, the CS 204 may select the best one that fits the needs sent from ET-SH 201. Overall, the selection criteria of LSA 202 may vary, such as: LSA 202 that is affiliated with a particular operator; LSA 202 that may help find desired LS-Cs 209 for the local services hosted by ET-SH 201; LSA 202 that is within the certain distance; LSA 202 that may be online in a fully 7×24 time window; or LSA 202 that may help ET-SH 201 to relocate its LS-Ss 205 to desired D-SHs; among other things.

At step 223 of FIG. 4, CS 204 may send back the response to ET-SH 201. For example, the following information may be included: the identified LSA(s) 202 or the access address (URI) or IP address of the identified LSA(s) 202.

In addition, it is worth noting that even if after completing the service provisioning procedure with CS 204, ET-SH 201 may still send subsequent discovery request to the CS 204 to identify desired LSA 202. The reason is that the information and availability of LSAs 202 may dynamically change and therefore ET-SH 201 may need to conduct dynamic discovery for identifying needed LSA 202. As a result, the above registration procedure as disclosed may also be utilized as a LSA discovery procedure with minimum modifications. For example, in step 221 of FIG. 4, instead of sending a provisioning type of request, a LSA discovery type of message may be sent but the same parameters may be included.

In addition, the above disclosed provisioning procedure may also be re-used when needing to conduct provisioning updates. For example, it is possible that after ET-SH 201 completed a service provisioning procedure with a CS 204, it may make some changes to its SH profiles 207 or the LS-S profiles 206 of its hosted LS-Ss 205. Accordingly, the ET-SH 201 may still send provisioning update message(s) to the CS 204 for updating such information.

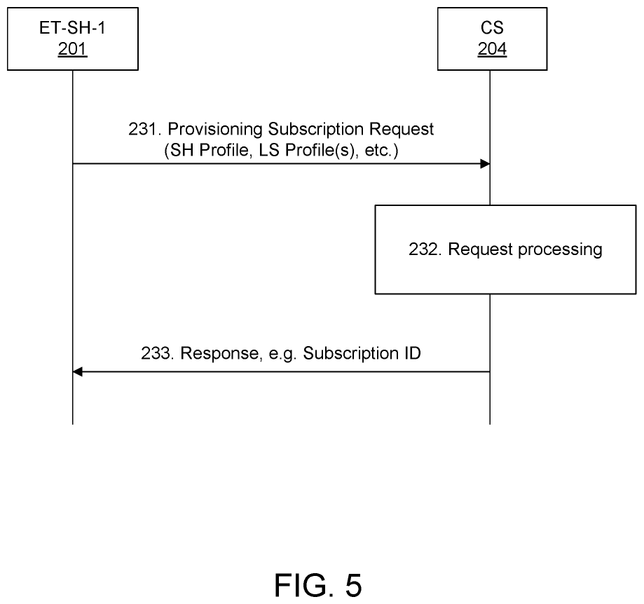

Design of Service Provisioning of ET-SH to a CS 204 (Subscription-Notification Model): In addition to using a Request-Response model, a subscription/notification mechanism may also be utilized. This may be useful when there is no available LSA(s) 202 meeting the needs of the ET-SH 201 initially. Accordingly, the ET-SH 201 may make a subscription to CS 204 so that it may be notified at a later time when the desired LSA(s) 202 become available. Herein a service provisioning procedure based on Subscription-Notification model is disclosed, which may enable ET-SH 201 to discover a nearby LSA 202 based on its needs (e.g., meeting a threshold or other criteria), and the details are illustrated with reference to FIG. 5.

At step 231 of FIG. 5, ET-SH 201 may send a service provisioning subscription request to CS 204 to ask some basic information of the Area-1, e.g., whether there is an available LSA 202 in Area-1, etc. It is also possible that ET-SH 201 may send its own information (e.g., as described in the SH profile of ET-SH 201) as well as the detailed information of its hosted LS-Ss 205 (e.g., as described in the LS-S profiles 206) so that CS 204 may help to find a desired LSA 202 which may meet their needs. In other words, in this request, the following information may be carried: 1) a SH profile 207 of ET-SH 201 (see Table 2); or 2) list of LS-S profiles 206 of the LSs hosted/deployed on ET-SH 201 (see Table 1).

At step 232 of FIG. 5, CS 204 may store the detailed information about ET-SH 201. After that, CS 204 may identify that currently there is no available LSA 202 in Area-1 that meets the selection criteria of ET-SH 201. Accordingly, the CS 204 my create a new subscription for ET-SH 201. At step 233 of FIG. 5, CS 204 may send back the response to ET-SH 201, along with a subscription ID.

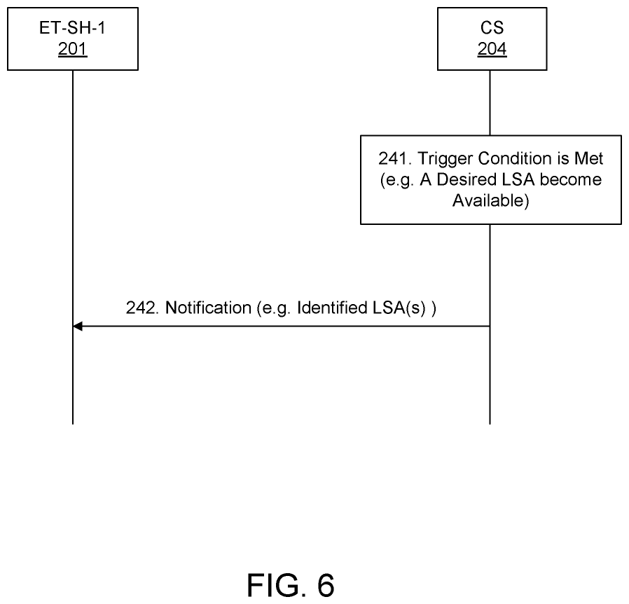

A notification procedure may be further defined in FIG. 6. With reference to step 241 of FIG. 6, one or more LSAs 202 may become available, and CS 204 may determine that there is a desired LSA 202 for ET-SH 201. Accordingly, CS 204 may decide to send a notification to ET-SH 201. At step 242 of FIG. 6, CS 204 may send a notification to ET-SH 201, and the following information may be included: subscription ID, the identified LSAs 202, or the access address (URI) or IP address of the identified LSAs 202.

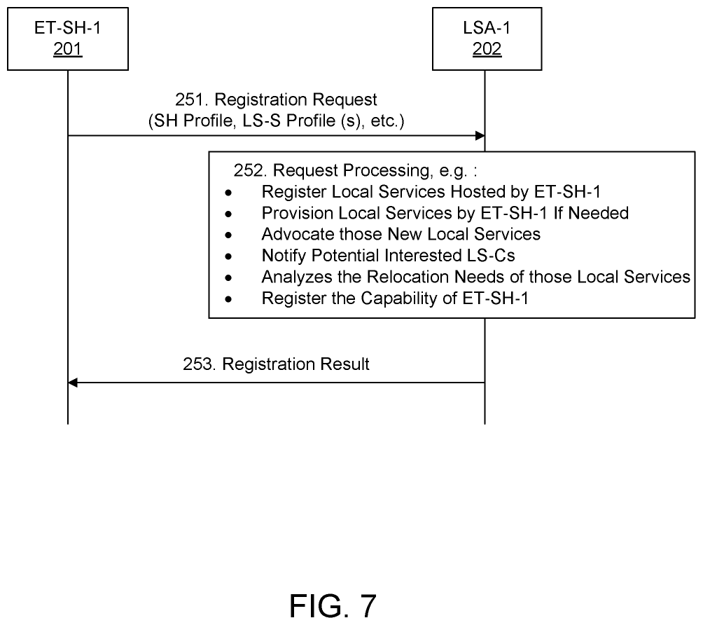

Once ET-SH 201 (e.g., a private UE, private vehicle, roadside unit, etc.) identifies a desired LSA 202 (e.g., LSA 202) via a CS 204, it may then register to the selected LSA 202 so that LSA 202 may provide LS management service to it. Herein, a service registration procedure is disclosed that may enable ET-SH 201 or an ECI-SH to register to a LSA 202, as illustrated with reference to FIG. 7.

Pre-condition: A SH (e.g., ET-SH 201) hosts a number of local services. The ET-SH 201 has identified LSA 202 via CS 204.

With reference to step 251 of FIG. 7, ET-SH 201 is hosting/running a number of LS-Ss. S-SH 216 has already identified that LSA 202 is a desired LSA 202 and ET-SH 201 already knows how to connect to LSA 202, e.g., via its URI or IP address, etc. Accordingly, ET-SH 201 may send a registration request to LSA 202. In this request, S-SH 216 may send its own information (e.g., as described in the SH profile 207) as well as the detailed information of its hosted LS-Ss 205 (e.g., as described in the LS-S profiles 206) so that LSA 202 may know how to serve ET-SH 201. In other words, in this request, the following information may be carried: 1) a SH profile 207 of ET-SH 201 (see Table 2); or 2) list of LS-S profiles 206 of the LSs hosted/deployed on ET-SH 201 (see Table 1).

At step 252 of FIG. 7, LSA 202 may receive the registration request, and it first makes sure ET-SH 201 has the right privilege(s) and the security credential(s). After that, LSA 202 may provide the following local service management operations for facilitating the LSs hosted by ET-SH 201: 1) register local services hosted by ET-SH 201; 2) provision local services by ET-SH 201; 3) advocate those new local services; 4) notify potential interested LS-Cs 209; 5) Analyzes the relocation needs of those local services; or 6) register the relocation capability of ET-SH 201.

LSA 202 may record/register the hosted LSs of ET-SH 201. In particular, the LS-S profiles of LS-Ss 205 hosted by S-SH 216 may be stored by LSA 202.

It is possible that in order to successfully run the LS-Ss 205 in a given area (e.g., Area-1 where LSA 202 oversees), certain information or data may need to be provisioned to the local services hosted by ET-SH 201, such as where to obtain current traffic/weather/people volume/event schedule information about Area-1. That information may be the inputs for running/configurating the local services hosted by ET-SH 201.

Advocate those new local services: LSA 202 may have the better knowledge regarding how to make those new local service hosted by ET-SH 201 available. For example, it is possible that there is a local service discovery directory in Area-1 and accordingly, the LSA 202 may further publish those local services to the discovery directory.

Notify potential interested LS-Cs 209: It is also possible that some LS-Cs 209 have already indicated their interests for certain types of local services via local service subscription to LSA 202. Accordingly, if one or more local service hosted by ET-SH 201 meet those needs, the LSA 202 may notify those potential LS-Cs 209.

Analyzes the relocation needs of those local services: On one hand, the LSs hosted by ET-SH 201 may have certain relocation needs, and the LSA 202 need to evaluate those needs and conduct future relocation operation when needed (e.g., when the relocation trigger condition meets).

Register the relocation capability of ET-SH 201: On the other hand, in the SH profile of ET-SH 201, it also specifies how the ET-SH 201 may serve the relocation needs for other SHs, e.g., how ET-SH 201 may act as a D-SH, e.g., what types of LS-Ss 205 that may be relocated to S-SH 216. Such information may be recorded by LSA 202 so that LSA 202 may choose ET-SH 201 for serving some relocation requests from other SHs.

At step 253 of FIG. 7, LSA 202 may send back the response to ET-SH 201. For example, the following information may be included: registration results; results of the local service management tasks that have been conducted (as listed in Step 252 of FIG. 7); or the like.

In addition, the above disclosed registration procedure may also be re-used when needing to conduct registration updates. For example, it is possible that after a SH has registered with a LSA 202, it may make some changes to its SH profiles or the LS-S profiles of its hosted LSs, accordingly, the SH may still send registration update message to the registered LSA 202 for updating that information.

In addition, in the disclosed procedure, some subscription or notification mechanisms may also be utilized and embedded. For example, during Step 252 of FIG. 7, if currently there is no available D-SHs meeting the relocation needs for the registering SH, the registering SH may make a subscription to LSA 202. Accordingly, it may still receive subsequent notifications when desired D-SHs become available, if currently there is no available D-SHs meeting the relocation needs (e.g., criteria) for the registering SH, the registering SH may make a subscription to LSA 202. Accordingly, it may still receive subsequent notifications when desired D-SHs become available.

In order for SHs (e.g., for ET-SHs 201) to discover available LSAs 202 in the given area, LSAs 202 may need to register themselves to CS 204.

When a LSA 202 is registering to a CS 204, it may need to share certain information with the CS 204. Accordingly, a LSA profile 210 is disclosed, which describes the information regarding a specific LSA 202, which is summarized in the Table 3.

TABLE 3
Local Service Assistant (LSA) Profile

| Information element | Description |
|---|---|
| LSA-ID | Identity of the SH. |
| LSA Affiliation | This is to indicate whether the LSA is |
| | private or owned by any organization, |
| | such as an operator. |
| LSA Schedule | The expected operation schedule of the |
| | LSA. For example, a LSA may only be |
| | operated during certain time periods. |
| Served Geographical Area | This is to show that this LSA may accept |
| | LS-S relocation requests from which |
| | locations, and/or areas. For example, a |
| | specific LSA 202 deployed in Area-1 may |
| | help in offloading requests from the ET- |
| | SHs 201 and ECI-SHs residing in Area-1. |
| LSA Access Address | This is to show an accessing address (such |
| | as URL or IP address and port) or |
| | endpoint address for connecting and |
| | interacting with the LSA. |
| LSA Capabilities | This parameter is to indicate what types of |
| | local service management operations may |
| | be supported by this LSA, e.g.: |
| | Register local services |
| | Provision/configure certain essential |
| | information to LSs if needed |
| | Advocate new local services |
| | Notify potential interested LS-Cs |
| | Analyzes the relocation needs of LSs |
| | Register the relocation capability of a |
| | SH |

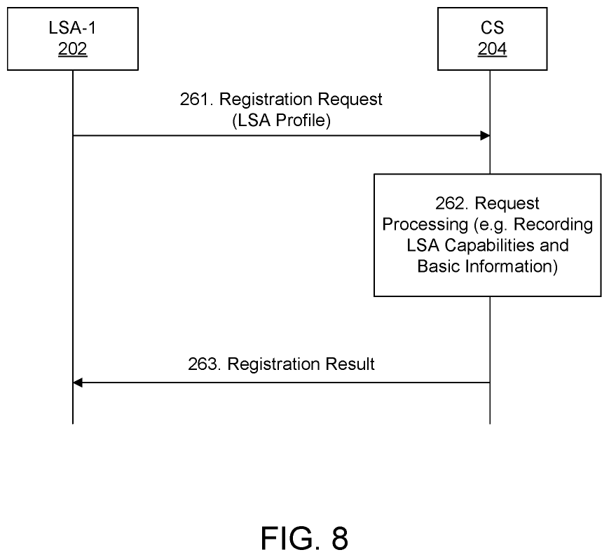

Herein, a LSA registration procedure may be disclosed, which may enable a LSA 202 to register to a CS 204, as illustrated with reference to FIG. 8. At step 261 of FIG. 8, LSA 202 may send a registration request to CS 204. Along this request, LSA 202 may send its own information (e.g., as described in the LSA profile of LSA 202) so that LSA 202 may be discovered by the potential SHs. In other words, in this request, the following information may be carried: a LSA profile of LSA 202 (the detailed information elements defined in the LSA profile in Table 3 may be the parameters carried in this request)

At step 262 of FIG. 8, CS 204 may receive the registration request, and it first makes sure LSA 202 has the right privilege(s) and the security credential(s). After that, the CS 204 may record the detailed information of LSA 202, which is described in the LSA profile.

At step 263 of FIG. 8, CS 204 may send back the response to LSA 202 regarding the registration status.

Disclosed below is a LS-C 209 perspective. A technical aspect is that given there are LSs available in a local area, how to enable LS-Cs 209 to discover those LSs? Herein are different approaches for LS-Cs 209 to discover available nearby local services (e.g., the LS-Ss). In particular, for a given LS-C 209, there may be at least the following approaches for it to discover available LS-Ss 205: 1) Proactive LS Discovery Via LSA 202; 2) Advertisement Via Underlying 3GPP Network; or 3) LS Advertisement Via LSA 202.

Proactive LS Discovery Via LSA 202. In this approach, it may be assumed that LS-Cs 209 may be pre-provisioning with a CS 204 in certain interested area. For example, the access address (URI, IP addresses, and ports) of a CS 204 in an Olympic park may be printed on the flyers, which may be handed out at the entrance of the park. Accordingly, when people enter into the park, they may use their UEs/smartphones (as potential LS-Cs 209) to scan the barcode printed on the flyers so that those UEs may know where to connect to the available CS 204 in the park. Via the CS 204, LS-Cs 209 may further identify available LSAs 202. Accordingly, the LS-Cs 209 may directly interact with a LSA for identifying available or interested LS-Ss 205 by proactively sending discovery requests. This may be based on the facts that during the LS registration process as discussed previously, the SHs have already shared their SH profile 207 as well as the LS-S profiles 206 of their hosted LS-Ss 205 with LSA 202. Accordingly, LSA 202 has the detailed information about the available LS-Ss 205 and therefore may help LS-Cs 209 to discover desired LS-Ss 205.

LS Advertisement Via Underlying 3GPP Network. In the previous approach, the basic methodology is that LS-Ss 205 may be proactively discovered by LS-Cs 209. In this approach, it is disclosed that as an SH, it may proactively disseminate the advertisements of its hosted LS-Ss 205 to the potential LS-Cs 209 by utilizing the broadcasting capability of the underlying 3GPP network. Accordingly, by receiving those ads, the LS-Cs 209 may know which LSs are available and start to enjoy them if they need.

LS Advertisement Via LSA 202. Instead of using an underlying network for LS advertisement, this approach uses LSA 202 for LS advertisement. In such a way, the LS advertisement may be realized at the service layer no matter what types of underlying transport networks are used.

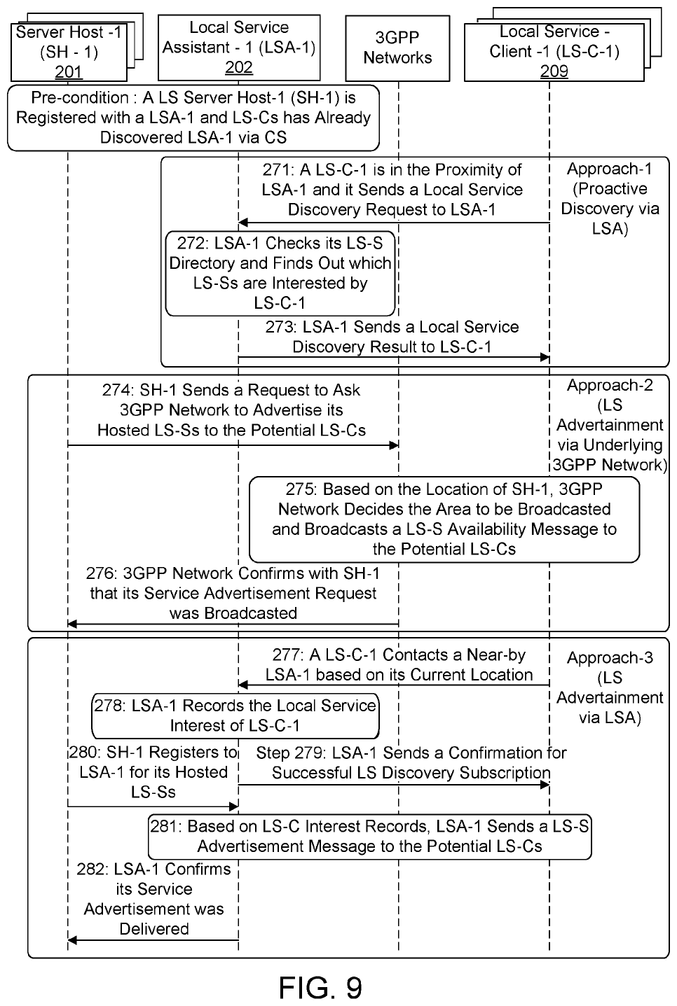

The detailed procedure of the disclosed approaches is described in the detailed procedure illustrated in FIG. 9.

Pre-condition: ET-SH 201 has already registered with LSA 202 in close proximity. Note that, ET-SH 201 or ECI-SH 208 are contemplated herein and SH may be an indication for either. SH profile 207 as well as the LS-S profiles 206 of the hosted LSs by ET-SH 201 have already been recorded and stored at LSA 202. In addition, LS-Cs 209 have already known the availability of the LSA 202 via a CS 204.

At step 271 of FIG. 9 through step 273 of FIG. 9 is the Approach-1 for local service discovery. In this approach, LS-Cs 209 may send explicit service discovery requests to the nearby LSA 202 to identify interested/available LS-Ss 205.

At step 271 of FIG. 9, an LS-C 209 (as one of the potential LS-Cs) may be in proximity of LSA 202 and it may send a local service discovery request to LSA 202. In particular, the following information may be carried in the request: desired local service list; current location of LS-C 209; or criteria, among other things. For each given desired LS-S Y, the following requirement (e.g., criteria) may be also specified: the local service type; the usage schedule of the LS-S, e.g., when LS-C 209 want to use LS-S Y; the desired performance of the LS-S Y, e.g., when sending a request to LS-S Y, when a response should be returned; or the cost option, e.g., the maximum cost LS-C 209 is willing to pay for using the LS-S Y. It is possible that LS-C 209 may just want to find free local services. Note that the Y in LS-S Y is just and indication that there may be one or more indicated LS-Ss (e.g., LS-S 1, LS-S 2, etc.).

At step 272 of FIG. 9, LSA 202 may check its local service directory and determine which LSs are of interest to LS-C 209. This may be based on a fact that SHs may have already shared their SH profiles 207 and LS-S profiles 206 with the LSA 202 during the LSA registration process as disclosed herein. Accordingly, LSA 202 may have the detailed information regarding which LS-Ss 205 are available and hosted by which SHs. For example, the detailed information as specified in the LS-S profile 206 may be used to evaluate the type of a specific LS-S Y, its basic KPIs, etc. In the meantime, from the SH profile 207 of the SH hosting LS-S Y, it may tell that what is the work schedule of this SH and accordingly when the LS-S Y may be available and serve LS-C 209 may be known.

At step 273 of FIG. 9, LSA 202 may send a local service discovery result to LS-C 209. The following information may be carried in the request: discovered LS-S list. In addition, for each discovered LS-S Y, the following information may be also specified: LS-S ID; local service type/description of this LS-S Y; operation schedule of this discovered LS-S Y; expected performance of the service, e.g., when sending a request to LS-S Y, when a response is expected to be returned; cost of using the LS-S Y; information/description of the SH hosting LS-S Y; or service access details, e.g., the IP 1 address for receiving incoming requests for LS-S Y; among other things.

As an alternative approach, if there are other LS discovery directories or portals that may facilitate LS discovery, LSA 202 may also publish its registered LSs to the LS discovery directory/portal, from which the potential LS-Cs 209 may conduct LS discovery.

Step 274 of FIG. 9 through step 276 is associated with Approach-2 for local service advertisement via underlying 3GPP network. In this approach, LSA 202 may proactively leverage the 3GPP network in order to send a broadcast for available LS-Ss 205 to the potential LS-Cs 209 in the proximity.

At step 274 of FIG. 9, ET-SH 201 may proactively send a request to ask 3GPP network to advertise its available local services to the potential LS-Cs 209. The following information may be carried in the request: LS-S list which may be provided by ET-SH 20; current location of ET-SH 201; or the like. In addition, for each given LS-S Y that is hosted by S-SH 216, the following information may be made available: LS-S ID; LS name; local service description/type of LS-S Y; operation schedule of the local service Y, e.g., when this local service is to be offline; expected performance of the Ls-S Y, e.g., when sending a request to LS-S Y, when a response is expected to be returned; cost of using LS-S Y. This may be related to charging model, e.g., when a request from an LS-C is sent to LS-S Y, if this request gets successfully processed, it may be charged for amount of service fee; or service access details, e.g., the access/IP address for receiving incoming requests for LS-S Y; among other things.

At step 275 of FIG. 9, based on the location of ET-SH 201, the 3GPP network may determine the geographical area to be broadcasted and may broadcast a local service availability message to the LS-Cs 209 which are in the proximity of ET-SH 201.

At step 276 of FIG. 9, 3GPP network may confirm that a local service availability broadcast has been sent to the potential LS-Cs 209.

As an alternative of Approach-2, the 3GPP network may also create a local service directory. Accordingly, the UEs (as potential LS-Cs 209) may discover those local services within the 3GPP network by accessing the local service directory.

Step 277 of FIG. 9 through step 282 of FIG. 9 is associated with the Approach-3 for local service advertisement via LSA 202. In this approach, the LS-Cs 209 may express their interests to a LSA 202. In the meantime, SHs may ask LSA 202 to proactively advertise their hosted LSs to the potential LS-Cs 209 (compared to the Approach-1 in which LS-Cs 209 may need to send discovery requests to LSAs 202).

At step 277 of FIG. 9, LS-C 209 may contact a nearby LSA 202 based on its current location. At step 278 of FIG. 9, LS-C 209 may indicate its interests to LSA 202 for the desired LSs. At step 279 of FIG. 9, LSA 202 may send a confirmation to LS-C 209 for successful LS discovery subscription. At step 280 of FIG. 9, ET-SH 201 may send a registration request to LSA 202 to register its hosted LS-Ss. At step 281 of FIG. 9, based on LS-C interest/subscription records, LSA 202 may send a LS-S advertisement message to the potential LS-Cs 209. At step 282 of FIG. 9, LSA 202 may confirm with ET-SH 201 that its service advertisement was delivered to the potential LS-Cs 209.

LS service discovery is disclosed above. An approach for the advanced distributed service discovery is disclosed below. For a given client (Client 214), Client 214 may have a need (e.g., certain criteria) to access a specific service (Service-A) with certain performance requirements (e.g., thresholds). Client 214 may operate similarly to LS-C 209 in FIG. 3. However, Client 214 does not really care about where Service-A is hosted. In other words, Service-A may be deployed in the cloud, or deployed at an ECI-SH 208, or may even be hosted by an ET-SH 201. However, when the instance of Service-A is hosted in different places, it may provide different performances. For example, a Service-A instance deployed in the cloud may have high scalability and reliability. However, accessing Service-A deployed in the cloud may have larger delay. In comparison, a client may access a Service-A that is directly hosted by a nearby ET-SH 201, and therefore it may provide minimum accessing delay although the computing or processing capability of the ET-SH 201 is limited. In addition, another balanced approach may be to access the Service-A instance hosted on an ECI-SH 208, which may have a better trade-off between the computing/processing capability and the access or response delay. In order to support advanced discovery, it multiple Service Discovery Servers (SDSs) may be deployed so that it may accept or process the service discovery requests from clients in order to identify desired services. For example, a LSA 202 may act as a SDS in a particular local area while another SDS may be deployed in the cloud.

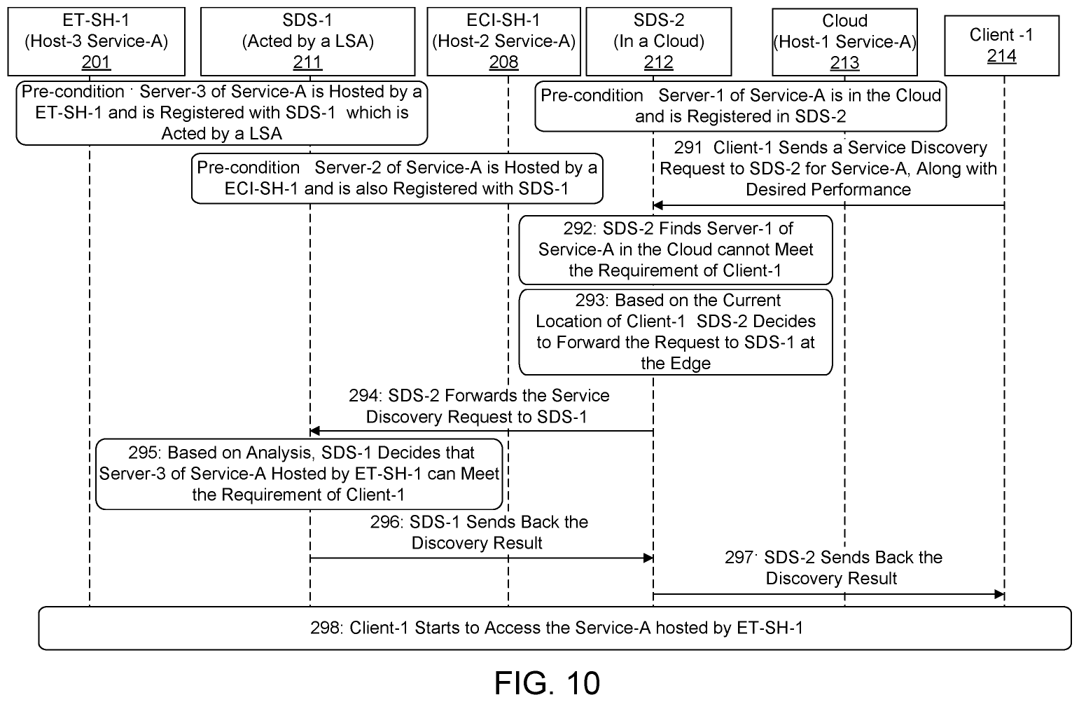

The detailed procedure of the disclosed two approaches is described in the detailed procedure illustrated in FIG. 10:

Pre-condition: There may be two SDSs in the system, e.g., LSA 202 is playing the role of a SDS (e.g., SDS 211) in the edge and another SDS 212 is deployed in the cloud. In particular, there are three server instances of Service-A in the system, which are deployed in the cloud, in an edge computing infrastructure (e.g., ECI-SH 208) and an edge terminal (e.g., a ET-SH 201) respectively. For example, Server-3 of Service-A is hosted by an ET-SH 201 and is registered with SDS 211. Server-2 of Service-A is hosted by an ECI-SH 201 and is also registered with SDS 211. In addition, Server-1 of Service-A is in the cloud and is registered in SDS 212.

At step 291 of FIG. 10, client 214 may send a service discovery request to SDS 212 for Service-A, along with desired performance. In particular, the following information may be carried in the request: desired service, e.g., Service-A; current location of Client 214; or performance requirements for accessing Service-A by Client 214, such as the access response delay; among other things.

At step 292 of FIG. 10, SDS 212 may determine Server-1 of Service-A in the cloud cannot meet the requirement of Client 214.

At step 293 of FIG. 10, based on the current location of Client 214, SDS 212 may decide to forward the request to SDS 211 at the edge.

At step 294 of FIG. 10, SDS 212 may forward the service discovery request to SDS 211, along with the desired performance requirement.

At step 295 of FIG. 10, SDS 212 may determine there are two available servers of Service-A, in which one is hosted by ET-SH 201 and the other is hosted by ECH-SH 208. Based on analysis, SDS 211 may determine that Server-3 of Service-A hosted by ET-SH 201 may meet the requirement of Client 214.

At step 296 of FIG. 10, SDS 211 may send back the discovery result, in which the access details of Server-3 hosted by ET-SH 201 is returned.

At step 297 of FIG. 10, SDS 212 further may send back the discovery result to Client 214.

At step 298 of FIG. 10, Client 214 may start to access the Service-A hosted by ET-SH 201 by interacting with the Server-3 of Service-A.

SH-Side-Initiated Service Relocation to ECIs. It may be a requirement to guarantee the QoS of the local services. However, when a local service is on an edge terminal, it is often difficult to keep desired KPIs due to the fact that the edge terminals may only have limited computing or storage capabilities and may not be capable for meeting certain QoS-related metrics. For example, due to the increasing accessing volume for a local service hosted by a mobile vehicle (as an ET-SH 201), the vehicle becomes overloaded because it cannot allocate sufficient resources to this local services. Therefore, the QoS of this local service may be downgraded, which is not desired. In order to keep consistent and sufficient QoS levels, an approach is disclosed associated with relocating the local service instance with the help of LSA 202. For example, when S-SH 216 (e.g., ET-SH 201, ECI-SH 208, or another SH) is hosting a specific LS-S X, it may dynamically decide when to relocate this LS-S X to D-SH 215 for the purpose of QoS management. For example, an SH may define a local service relocation policy or a number of relocation conditions (as specified in the LS-S profile 206), which defines the conditions when LS-S X should be relocated to a desired D-SH 215. Accordingly, once the condition is met, S-SH 216 may initiate service relocation task by sending a local service relocation request to LSA 202, and LSA 202 may further handle the detailed operations for this task. For example, LSA 202 needs to consider the needs for this service relocation task and find an appropriate D-SH 215 to host the relocated LS-S X instance. There may be different ways for how LSA 202 may serve the relocation request for LS-S X hosted by S-SH 216, such a reactive approach or proactive approach.

In a reactive approach, during the registration of LS-S X to LSA 202 (as defined previously), LSA 202 may not initiate any relocation processing, e.g., to find available D-SHs 215 for LS-S X. This reactive approach may be beneficial when the potential D-SHs 215 may have dynamic changes and it may not be necessary to find and assign D-SH(s) 215 in advance for serving relocation requests of LS-S X. Instead, LSA 202 may start to work on the relocation requests when the relocation trigger conditions are met, which may trigger an LS-S 205 relocation to be initiated.

In comparison, another approach is a proactive approach. In this approach, LSA 202 may initiate certain pre-relocation processing, e.g., to find available D-SH(s) 215 and assign them for serving the upcoming future relocation needs of the LS-S X. This proactive approach may be beneficial when the potential D-SHs 215 have relatively fewer dynamic changes. For example, some of ECI-SHs 208 may be edge computing infrastructures, which are owned by commercial teleoperators and may have sufficient computing or storage resources (e.g., they can serve relocation needs). In the meantime, those ECI-SHs 208 may just be fixed (deployed in an edge data network). In such a case, those ECI-SHs 208 may act as D-SHs 215 and it may make sense for LSA 202 to find and assign desired ECI-SH(s) 208 as D-SHs 215 for serving the future relocation request(s) of LS-S X.

Once a new LS-S X instance is running at a selected D-SH 215, LSA 202 may also need to advertise the availability of this new LS-S X instance to all or subset of LS-Cs 209 so that the incoming requests may be forwarded to the new instance of LS-S X hosted on the D-SH 215 instead of still sending the LS access requests to the original S-SH 216 for processing. At a later time, the S-SH 216 may also send another request to LSA 202 in order to terminate a relocated LS-S X on the D-SH 215 (e.g., when S-SH's 216 workload returns to a normal (threshold) level and it is able to serve requests by itself).

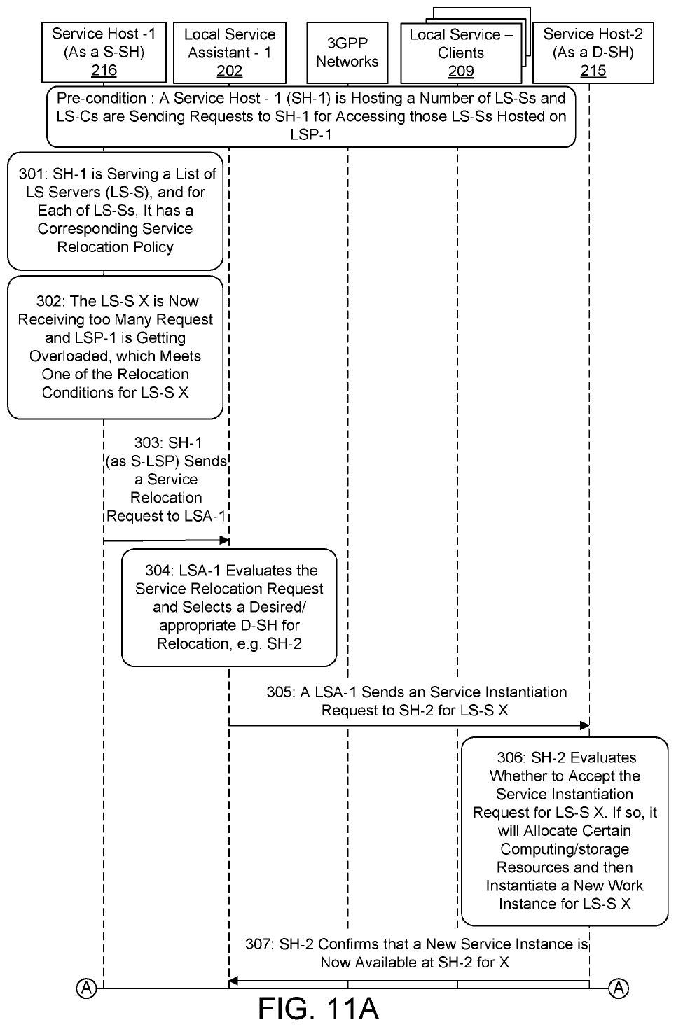

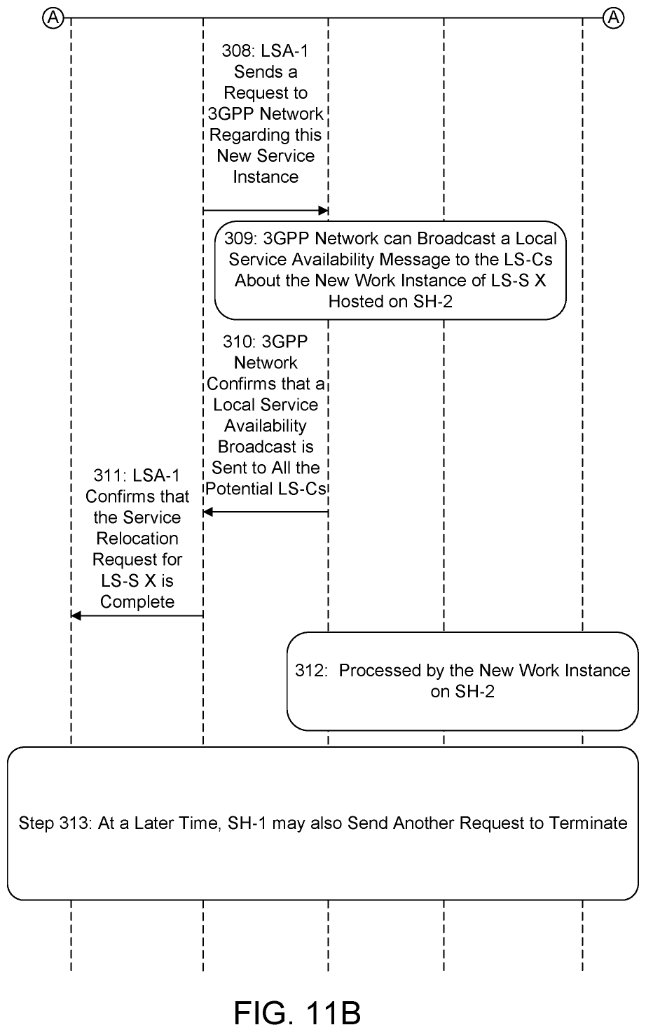

The corresponding procedure may be illustrated in FIG. 11A-FIG. 11B and the detailed descriptions are as follows.

Pre-condition: A Server Host, S-SH 216, is providing a list of local services and LS-Cs 209 are sending requests to S-SH 216 for accessing those LS-Ss 205 hosted on S-SH 216.

With reference to step 301, S-SH 216 is serving a list of LS-Ss 205, and for each of LS-Ss 205, it has a corresponding service relocation policy and trigger conditions, which are specified in the LS-S profiles 206. For a given LS-S X, its corresponding relocation policy may have the following action triggering conditions, For example, relocation action for a LS-S X may be initiated when the following QoS-related or other conditions are met: the number of requests reaches a certain upper threshold during a given time interval; the software instance of LS-S X has reached a certain level of utilization/loading (e.g., 90%); the processing time cost or the delivery delay for each of the requests targeted to LS-S X hosted on S-SH 216 reaches a certain threshold; the remaining energy of S-SH 216 reaches a certain low threshold (remember that normally SHs only have the limited computing/storage as well as energy resources); the communication links between S-SH 216 and its LS-Cs 209 exceed a certain bandwidth utilization threshold; or other conditions observed by S-SH 216 that trigger S-SH 216 to start relocation.

In the meantime, it is possible that D-SH resources may not be free for an S-SH 216. In this case, an S-SH 216 may need to utilize D-SH resources in a most efficient manner. In particular, when an S-SH 216 does not need certain instances of its relocated local services to be run on the D-SH 215, it may terminate the relocated instances in order to avoid unnecessary charges or costs. Accordingly, a termination action for a LS-S X may be initiated by S-SH 216 when: the number of requests returns back to threshold normal, and the S-SH 216 is able to handle those requests by itself; the software instance of LS-S X hosted on SH 216 is not overloaded anymore and is expected to provide desired QoS performance; the energy of S-SH 216 returns back to a threshold sufficient level; the communication links between S-SH 216 and its LS-Cs 209 drop below a certain bandwidth utilization threshold; or meeting other criteria (e.g., threshold levels).

With reference to step 302, the LS-S X is now receiving too many requests and S-SH 216 is getting overloaded (e.g., reached a threshold overload condition), which meets one or more of the relocation triggering conditions for LS-S X.

At step 303, S-SH 216 may send a service relocation request to LSA 202 in order to relocate LS-S X to D-SH 215.

At step 304, LSA 202 may evaluate the service relocation request and may select a desired/appropriate D-SH 215 for relocation. When an SH registers with a LSA 202, LSA 202 may have multiple ways to assign a desired D-SH(s) 215. For example, for a given LS-S X hosted by S-SH 216 my engage in a reactive approach or proactive approach. In a reactive approach, LSA 202 may not initiate any relocation processing, e.g., to find available D-SH(s) 215 for the LS-S X hosted by S-SH 216 during the registration stage. In a proactive approach, LSA 202 may initiate certain relocation processing, e.g., to find available D-SH(s) 215 and assign them for serving the upcoming future relocation needs of the LS-S X hosted by S-SH 216.

Accordingly, in this step, if LSA 202 has already assigned SHs as D-SH 216 for LS-S X hosted by S-SH 216 when S-SH 216 was registering to the LSA 202, then LSA 202 may directly contact with the assigned D-SHs 215 for the relocation needs. If not assigned before, the LSA 202 may need to dynamically select an appropriate D-SH 215 now.

With reference to step 305, assuming in step 304, LSA 202 determines that D-SH 215 is desired destination, then, in this step 305, LSA 202 may send a service instantiation request to D-SH 215 for LS-S X. In particular, in this request, the LSA 202 may need to specify the following information (which may be based on the LS-S profile 206 of X): LS-S ID of X; the service instance software installation instruction; the required computing/storage resources to be allocated to this new instance of LS-S X; the required QoS performance that needs to be met; the expected availability schedule. For example, this new instance of LS-S X shall be available and ready for processing the requests during 8 am and 8 pm; or any other requirements for running LS-S X (e.g., security or privacy related).

At step 306, D-SH 215 may evaluate whether to accept the service instantiation request for LS-S X. If so, D-SH 215 may allocate the required computing/storage resources and then instantiate a new instance for LS-S X. For example, during this processing, the D-SH 215 may need to evaluate whether it is willing to host this LS-S X at this time point. In some cases, for a LS-S X, in step 304, it may require that in order to run an instance of X, a host needs to at least have a certain level of security/privacy protection. Another example, D-SH 215 may also need to check the service instance software installation packet in order to evaluate whether the new instance of X may be successfully installed on D-SH 215.

With reference to step 307, after a new instance is successfully installed on D-SH 215, it may activate this instance (or activate it at a later time based on certain triggers). Then, D-SH 215 may confirm that a new service instance is now available at D-SH 215 for LS-S X. In the meantime, D-SH 215 also provides the new access details for accessing this new instance.

At step 308, once the new instance is available at D-SH 215, there may be a step to make all (or part of) the potential LS-Cs 209 of local service X be aware of this new instance. Since most of LS-Cs 209 are UEs and are associated with a 3GPP network. Therefore, one of the approaches to do so is that S-SH 216 or LSA 202 may send a request to the 3GPP network regarding this new instance on D-SH 215 for LS-S X.

With reference to step 309, the underlying 3GPP network may have also different approaches. The first approach may be that the 3GPP network may broadcast a local service availability message to the LS-Cs 209 about the new instance of LS-S X hosted on D-SH 215. In this approach, since most of the LS-Cs 209 may be aware of the new instance of X hosted on D-SH 215 then for future service access requests, the LS-Cs 209 will directly send their requests to the new instance (another two alternative approaches as defined in FIG. 9 may also be adopted). The second approach is that the 3GPP does not broadcast a local service availability message for the new instance of X hosted on an D-SH 215. Instead, 3GPP network may need to configure traffic steering policies in 3GPP network so that the LS-Cs 209 may still send their requests towards the original instance of LS-S X hosted on S-SH 216 but those requests may now be forwarded or steered to the new instance on D-SH 215. It may be seen that in this approach, the service relocation is fully transparent to the LS-Cs 209.

With reference to step 310, assuming the 3GPP network adopted the first approach as described in Step 309, then the 3GPP network may confirm (e.g., determine) that a local service availability broadcast is sent to the prospective LS-Cs 209.

At step 311, LSA 202 may confirm that the service relocation request for LS-S X is complete.

With reference to step 312, now when LS-Cs 209 are sending new requests for accessing LS-S X, those requests will be processed by the corresponding instance on D-SH 215. Alternatively, partial offloading may also be conducted. In other words, some of the new requests may be processed by the instance on D-SH 215 and the remaining ones may still be process by S-SH 216.

With reference to step 313, at a later time, D-SH 215 may also send another request to terminate the instance of X hosted by D-SH 215 based on the policy as described in step 301 (e.g., when S-SH 216 is able to serve the requests by itself again). Accordingly, the instance hosted on D-SH 215 may be terminated and the resources may be released. In the meantime, the LSA 202 may further send requests to the 3GPP network so that the requests may be sent to S-SH 216 for processing.

LSA-side-Initiated Service Relocation to ECIs. In this approach, instead of letting an SH decide when to relocate a particular local service, LSA 202 may proactively make this decision on behalf of an SH. The reason is that most of the time, LSA 202 may have more information about the system and therefore LSA 202 may be in a better position to make a sound decision for local service relocation. For example, LSA 202 may leverage the 3GPP network to collect related statistics about LS-Cs 209, e.g., whether there is an increasing number of LS-Cs 209 that are interested in a particular local service in a given area. Accordingly, instead of allowing an SH to reactively issue a local service relocation request, e.g., when the SH is already overloaded (e.g., reached a threshold number of requests within a period or another threshold that may affect the performance of the local service) and QoS metrics are already downgraded (since this is the most obvious/direct factor for the SH to ask for service relocation), LSA 202 may foresee the future service demand and proactively relocate a local service. In this way, it may more efficiently manage the overall system by proactively initiating service relocation.

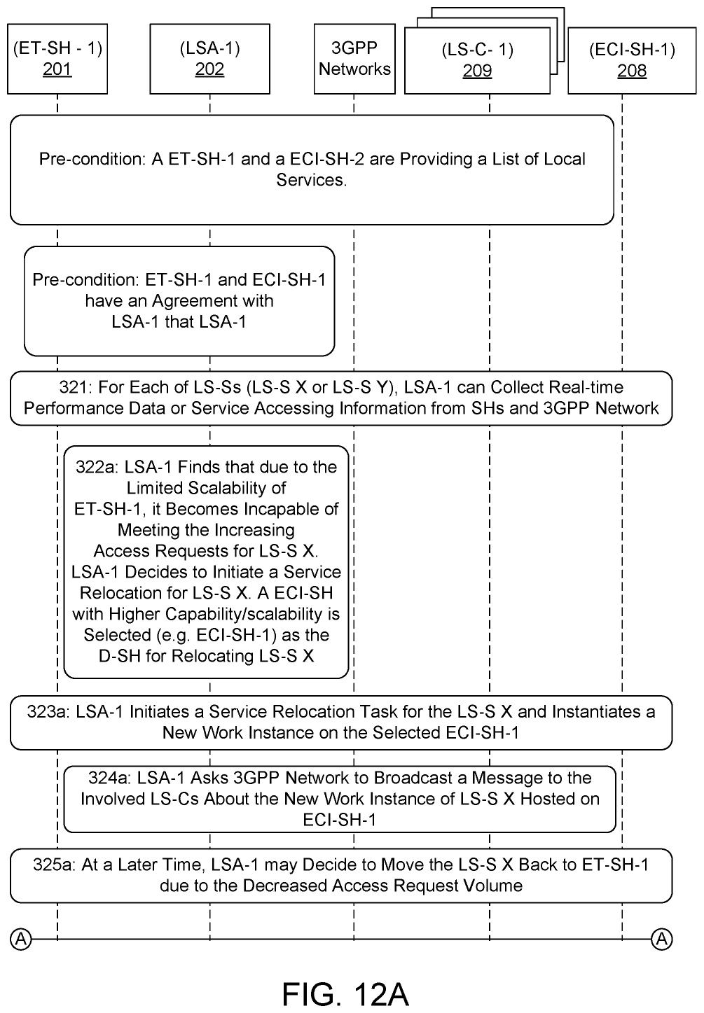

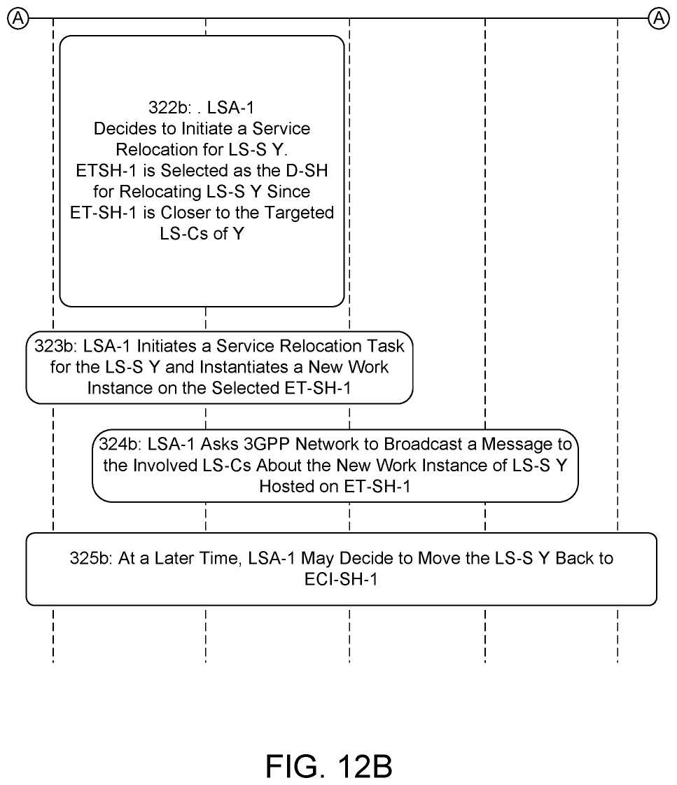

The corresponding procedure may be illustrated in FIG. 12A-FIG. 12B and the detailed descriptions are as follows. Pre-condition: An ET-SH 201 (e.g., a SH in a field, such as in a park, in a factory, or in an event site) and a ECH-SH 208 (e.g., an edge computing facility that is in a regional computing center) are providing a list of LS-S respectively. LS-S X may be originally hosted by ET-SH 201 while the LS-S Y may be originally hosted by ECH-SH 208. Pre-condition: ET-SH 201 and ECH-SH 208 have agreements with LSA 202 that LSA 202 may make service relocation decisions on behalf of them.

At step 321, for each of LS-Ss 205 (LS-S X or LS-S Y), LSA 202 may collect real-time performance data or service accessing information from SHs and 3GPP network. There are several information sources that LSA 202 may collect related data from the SHs or 3GPP network. The SHs (including ET-SH 201 or ECH-SH 208) may send performance or QoS related data to LSA 202 for local services hosted on them, for example: whether software instance of LS-S X on ET-SH 201 has been in busy status in most of the time (e.g., 90%); or whether the response delivery delay for each of the requests targeted LS-S Y hosted on ECH-SH 208 reaches certain threshold. The 3GPP network may also send related data to LSA 202, for example: how many requests are current sent towards the LS-S X hosted on ET-SH 201; or where the access requests towards the LS-S Y are sent from, e.g., from which LS-Cs 209, from which area/location, or from which gNodeB mostly.

Below, two examples are presented for illustration purpose, e.g., the a-steps are for LS-S X while the b-steps are for LS-S Y.

At step 322a, based on the collected information, LSA 202 may determine that due to the limited scalability of ET-SH 201, ET-SH 201 becomes incapable of meeting the increasing access requests and QoS performance metrics for LS-S X. The reason is that the ET-SH 201 is just a mobile terminal such as a private UE, therefore it only has limited capacity for processing the received access requests of LS-S X. As a result, LSA 202 decides to initiate a service relocation for LS-S X. In particular, a commercial edge infrastructure may be a good candidate for supporting the relocation due to its more powerful computing or storage capacity. As a result, an ECI-SH 208 with higher capability or scalability may be selected as the D-SH for relocating LS-S X.

At step 323a, LSA 202 may initiate a service relocation task for the LS-S X and may initiate a new work instance on the selected ECH-SH 208. Note that, this step may be involved with several rounds of interaction and negotiation as well as new instance instantiation.

At step 324a, LSA 202 may request from a 3GPP network to broadcast a message to the involved LS-Cs 209 about the new work instance of LS-S X hosted on ECH-SH 208. In the meantime, 3GPP network may also configure traffic steering policies so that the request towards LS-S X hosted on ET-SH 201 may now be forwarded to the work instance on ECH-SH 208.

At step 325a, at a later time, LSA 202 may decide to move the LS-S X back to ET-SH 201 due to the decreased access request volume. This is possible when there are less LS-Cs 209 that are using the LS-S X. In such a case, it means that ET-SH 201 may fully handle such a workload. As a result, the LS-S X may be moved back and re-loaded to ET-SH 201 and LSA 202 also releases the relocated working instance of LS-S X on ECH-SH 208.

At step 322b, similarly, LSA 202 may determine that the LS-S Y hosted on ECH-SH 208 are too far (e.g., a threshold distance) from the targeted LS-Cs 209 and leading to increasing service delivery delay. For example, it may be possible that ECH-SH 208 is located in Area-1 while the most of targeted LS-Cs 209 of LS-S Y are from another Area-2. As a result, due to the distance between the two areas, the service delivery delay may not be accepted to the LS-Cs 209 of the LS-S Y. Because of the aforementioned, LSA 202 may intend to find another desired or on-site SH for relocating LS-S Y so that the service delivery delay may be significantly reduced. For example, LSA 202 may decide to initiate a service relocation for LS-S Y and in particular, ET-SH 201 (just as an example) is selected as the D-SH for relocating LS-S Y since ET-SH 201 is staying in Area-1 and much closer to the targeted LS-Cs 209 of LS-S Y.

At step 323b, LSA 202 may initiate a service relocation task for the LS-S Y and may instantiate a new work instance on the selected ET-SH 201. Note that, this step may be involved with several rounds of interaction and negotiation as well as new instance instantiation.

At step 324b, LSA 202 may send a request to a 3GPP network to broadcast a message to the involved LS-Cs 209 about the new work instance of LS-S Y hosted on ET-SH 201. In the meantime, 3GPP network may also configure traffic steering policies so that the request towards LS-S Y hosted on ECH-SH 208 may now be forwarded to the work instance on ET-SH 201.

With reference to step 325b, at a later time, LSA 202 may decide to move the LS-S Y back to ECH-SH 208. For example, during a period, the targeted LS-Cs 209 of LS-S Y may have moved around. In particular, those LS-Cs 209 may move into the Area-2 and as a result, ECH-SH 208 is now much closer to those LS-Cs 209 since ECH-SH 208 is just located in Local Area-2. As a result, LSA 202 may decide to move the LS-S Y back to the ECH-SH 208 and then release the relocated working instance of LS-S Y on ET-SH 201.

In 3GPP SA6, the specification TS 23.558 defines an Application Architecture for Enabling Edge Applications, in which there are several functional entities, such EES, EEC, EAS, or AC. Edge Enabler Server (EES) provides supporting functions needed for Edge Application Servers to run in an Edge Data Network. Edge Enabler Client (EEC) provides supporting functions needed for Application Client(s). Edge Application Server (EAS) may be an application server resident in the edge hosting environment. Application Client (AC) may be application software resident in the UE performing the client function.

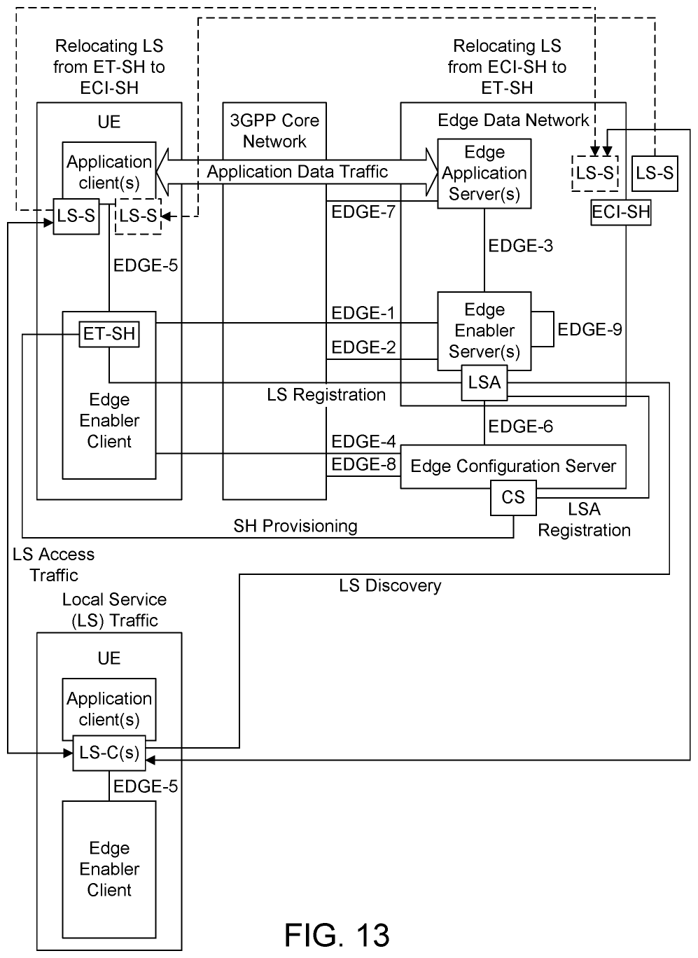

In 3GPP, it is disclosed that the entities defined in this disclosure may include the following, which is illustrated in FIG. 13. In Edge Terminal may be mapped to a UE. A Local Service-Server (LS-S) may be mapped to an Edge Application Server defined by 3GPP, if in the future 3GPP release, a EAS may also be hosted by a UE. A LS-S may also be mapped to an Application Client defined by 3GPP if it needs certain help from other entities. The Server Host (SH) may be mapped to a UE (as an ET-SH) or a node in the network hosting an EAS (as a ECI-SH). The disclosed Local Service Assistant (LSA) may be realized by Edge Enabler Server or Edge Configuration Server defined by 3GPP. The Local Service-Client (LS-C) may be mapped to the UEs requiring or accessing the local services. In 3GPP SA6 context, a LS-C may also be mapped to be an Application Client defined by 3GPP, those Application clients may access EASs. The Edge Computing Infrastructure (ECI) may be mapped to the Local Data Network (LDN) defined by 3GPP. Accordingly, the LS-Ss 205 hosted by ECI may be mapped to edge application server (EAS) in 3GPP context. The Configuration Server (CS) defined in this disclosure may be mapped to the Edge Configuration Server (ECS) or Edge Enabler Server as defined by 3GPP. The entity relations disclosed herein for 3GPP or the like are just examples and it is contemplated that the functionality for the disclosed subject matter may be placed in other entities not mentioned.

Based on the above entity relations to the 3GPP entities, the disclosed procedures in the previous procedures may be related to the corresponding procedures or messaging between the corresponding 3GPP entities as defined the corresponding 3GPP specs, e.g., 3GPP TS 23.558.

Below are a summary of different approaches for local service management.

Service Provisioning of ET-SH to a CS-Approach 1: Edge terminal (ET) 201 may host various local services (LSs) and may have a corresponding server host (SH) profile 207, wherein the SH profile 207 may describe ET 201 itself (as a server host). ET 201 may locally host a number of servers of local services, or denoted as Local Service-Servers (LS-Ss) (e.g., LS-S 205a or LS-S 205b), wherein a LS-S 205 has a corresponding LS-S profile 206 that is to describe the information about a specific LS. ET 201 may send a service provisioning request to a configuration server (CS) 204 in order to discover available LSA 202 in a first area of interest (e.g., Area-1). The service provisioning request may include SH profile 207 of ET 201 or a list of LS-S profiles 206 for the LSs hosted by ET 201. Example detailed information elements of a LS-S profile 206 are listed in Table 1. LS-S profile 206 may specify certain needs or discovery criteria for the desired LSA 202.

ET 201 may receive a response from CS 204. The response may include the following information: 1) the identified LSA(s) 202 or 2) the access address (e.g., URI) or IP address of the identified LSA(s) 202.

An approach 2A (e.g., Service Registration Procedure of SH (e.g., ET-SH 201 or ECI-SH 208)) to a LSA) may be executed from a SH perspective. A SH may be ET-SH 201 or ECI-SH 208. ET-SH 201 may host various Local Services (LSs), and has a corresponding SH profile 207, wherein the SH profile 207 is to describe entity itself (as a server host). ET-SH 201 may identify a desired LSA (e.g., LSA 202) through approach 1.

ET-SH 201 may send a registration request to LSA 202. The registration request may include SH profile 207 of ET-SH 201 (or a link to such profile) or a list of LS-S profiles 206 of the LSs hosted by the server host, in which a LS-S profile 206 specifies different sets of information elements regarding a particular LS-S 205. There may be information elements of corresponding LS of LS-S 205 (e.g., corresponding LS identifier, description, etc.). There may be information elements (IEs) of SHs that may host LS-S 205 (e.g., mobility profile of the server host). There may be information elements of basic characteristics of LS-S 205 (e.g., the service coverage, service schedule, expected QoS performance, access endpoints/URI, etc.). There may be information elements of potential LS-Clients 209 of LS-S 205 (e.g., who may access this LS-S, access priority, etc.). There may be information elements related to LS-S discovery mechanism used by LS-Cs 209 (e.g., how this LS-S may be advertised and discoverable). There may be information elements related to LS-S relocation trigger conditions and needs (e.g., how this LS-S shall be relocated due to certain triggers, e.g., to meet certain QoS performance).

The SH may receive a response from the desired LSA 202, wherein the following information may be included: the registration result; the assigned D-SH(s) that may serve the future relocation needs for the server host, etc.

An approach 2B (e.g., Service Registration Procedure of SH (e.g., ET-SH or ECI-SH) to a LSA) may be executed from a LSA perspective. LSA 202 may receive a registration request from a first Server Host (SH) (it could be ET-SH 201 or an ECI-SH 208). The registration request may include SH profile of the first SH or a list of LS-S profiles 206 for the local services hosted by the first SH.

LSA 202 may conduct the local service management operations for facilitating the LSs hosted by the first SH. An operation may include registering local services hosted by the first SH. An operation may include provisioning local services by first SH (e.g., provides necessary information). An operation may include advocating (e.g., advertising) the new local services (e.g., advertises or publishes the local services). An operation may include notifying potential interested LS-Cs 209 (e.g., notifies some targeted LS-Cs 209). An operation may include analyzing the QoS objectives and corresponding relocation needs of those local services (e.g., how the first SH's relocation may be served in order to meet certain QoS performance). An operation may include registering the relocation capability of the first SH (e.g., how the first SH may serve relocation requests from other SHs) wherein the following information may be included. The information may include the types of LS-Ss 205 that may be accepted/offloaded by/to the first SH, the working schedule of the first SH for serving relocation needs, or the like.

LSA 202 may send a response to the first SH, wherein the following information may be included. The information may include the registration result; the needed provisioning information from LSA 202, whether the LS-Ss 205 hosted by first SH have been advertised; whether certain interested (e.g., targeted) LS-Cs 209 have been notified; whether the first SH will participate for serving relocation needs from other SHs, or the like.

An approach 3A (e.g., Local Service Discovery) may be executed from LSA 202 perspective. LSA 202 may be registered with a list of LS-Ss 205 in its local directory. LSA 202 may receive a local service discovery request from a first local service client (denoted as a LS-C 209), wherein the LS discovery request may carry the following information. The information may include desired local services; current location of the LS-C 209; or for each desired local service Xbased on requirements. The following requirements (e.g., criteria) may be also specified by the local service type, the usage schedule of the LS-C, e.g., when LS-C 209 want to use local service X, the desired performance of the local service X, or the like.

LSA 202 may check SH profile 207 and LS-S profiles 206 stored in the local directory and finds out which local services are of interest to the first local service client 209.

LSA 202 may send a local service discovery result to the first local service client, wherein the following information may be included, such as the discovered local service list. For each discovered local service X, the following information may be also specified: the local service ID; the local service type/description; the operation schedule of this discovered LS; the expected performance of the local service; the cost for using the local service; the information/description of the SH hosting the local service X; or the service access details, e.g., the IP 1 address and port for service access requests for the local service X.

An approach 3B (e.g., Local Service Advertisement via 3GPP Network) may be executed from LSA perspective. LSA 202 may have a registered a list of local services (LS-Ss) in its service directory. LSA may send a local service advertisement request to ask 3GPP network to advertise its available local services to the potential local service clients, wherein the following information may be carried in the request. For each local service X, the following information may specified: local service ID; local service type/description; operation schedule of this LS; expected performance of the local service; cost for using the local service; information/description of the SH hosting the local service X; or service access details, e.g., the IP 1 address and port for service access requests for the local service X.

LSA 202, based on the availability of a local service X and its corresponding server host, may request the 3GPP network to broadcast a local service availability advertisements to certain geographical areas in which the potential local service clients could access the local service X.

LSA 202 may receive a confirmation from the 3GPP network that a local service availability broadcast has been disseminated to all the potential clients.

An approach 4 (e.g., SH-side-Initiated Service Relocation to ECIs) may be executed from SH. A SH may be at an edge terminal (e.g., ET-SH 201) or edge infrastructure (e.g., ECI-SH 208). SH may locally hosts a first instance of a Local Service Server (LS-S) 205. SH may receive requests to configure one or more policies for relocating the local service server in order to meet certain QoS objectives (e.g., criteria). SH may receive local service access requests from Local Service Clients (LS-Cs) 209 that target the first instance of LS-S. SH may detect that a trigger condition, defined by a policy, is met for initiating the relocation of the first instance of LS-S to a second LS server host (e.g., an ECI server host). SH may send a service relocation request to a network entity (e.g., LSA 202) for the first local service server to be relocated. SH may receive a response indicating that future LS access requests targeting the first local service server will be redirected to the second local service server, which is instantiated on the second LS server host. SH may detect that a trigger condition, defined by a policy, is met to stop redirecting the access requests to the second LS server. SH may send a request to a network entity (e.g., LSA) to stop redirecting incoming requests targeting the first local service server to the second local service server. SH may receive a response indicating that request redirecting is stopped. SH may receive a response indicating that the second local service server instantiated on the second LS server host has been successfully terminated.

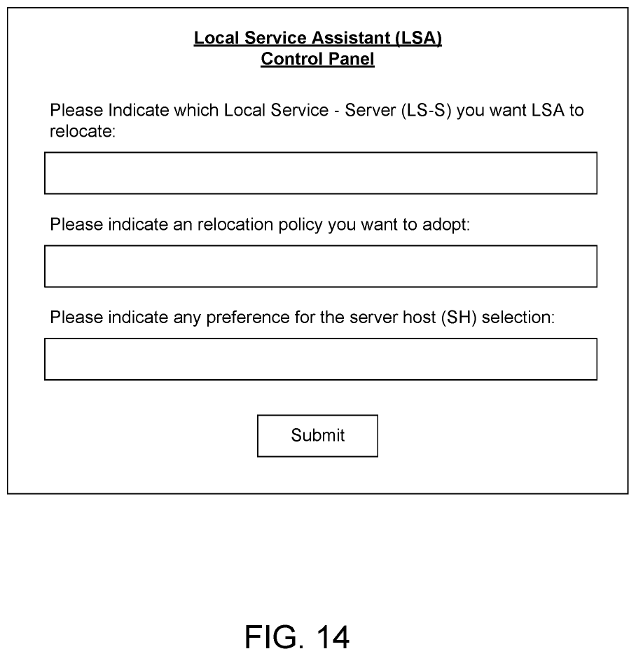

A graphical user interface (GUI) interface is disclosed in FIG. 14, which may be used for a human user to manage the task of the Local Service Assistant (LSA). For example, based on user's plan, a human user may proactively add a task for LSA 202, which is to relocate a specific local service server to a server host due to QoS management operation. In the meantime, the human user may also indicate what type of relocation policy/trigger should be used. In addition, the user may also indicate whether the user has certain preference for the edge computing infrastructure or an edge terminal selection as the D-SH. After submitting this request, LSA 202 will process the request. For example, LSA 202 will contact the involved server host to see if the local service server needs to be relocated based on various trigger conditions, e.g., for related to QoS management or other purposes.

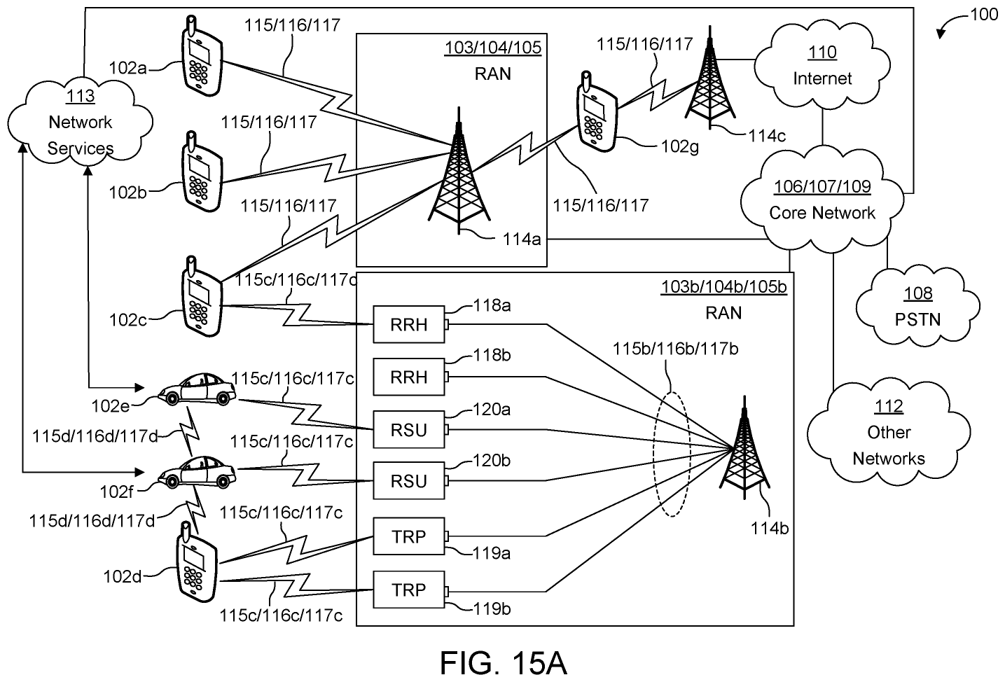

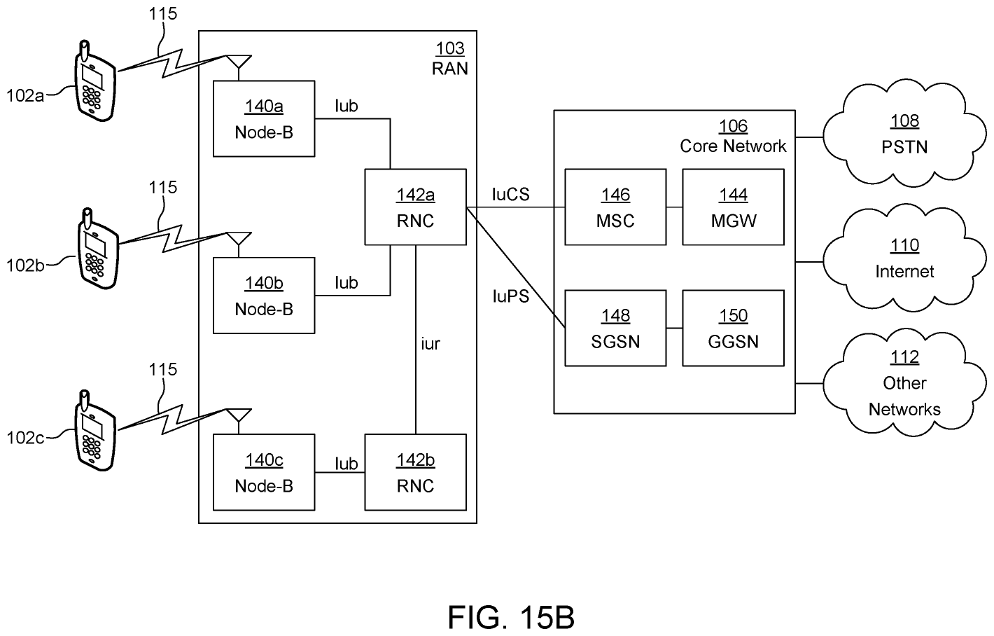

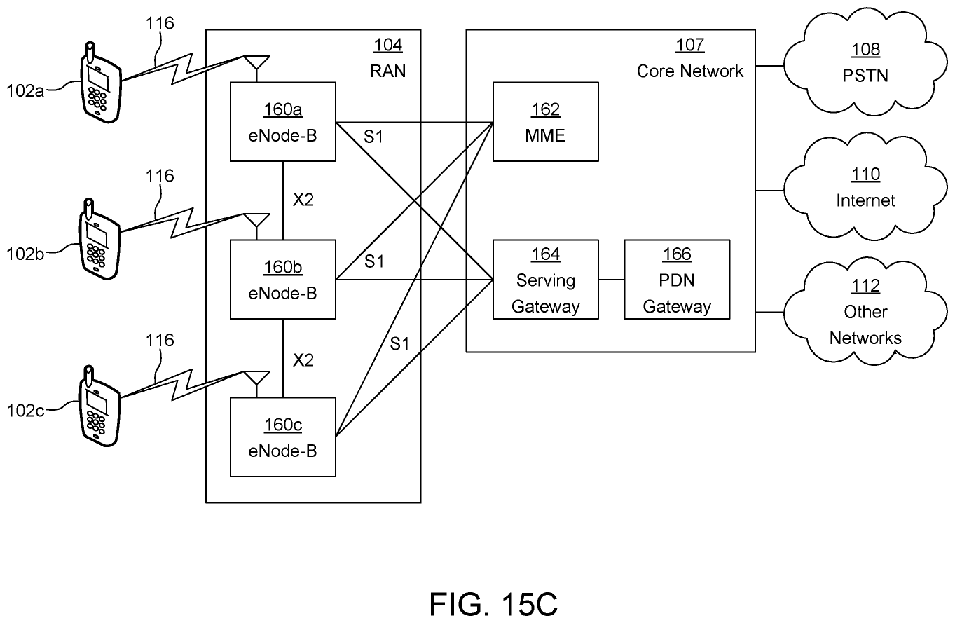

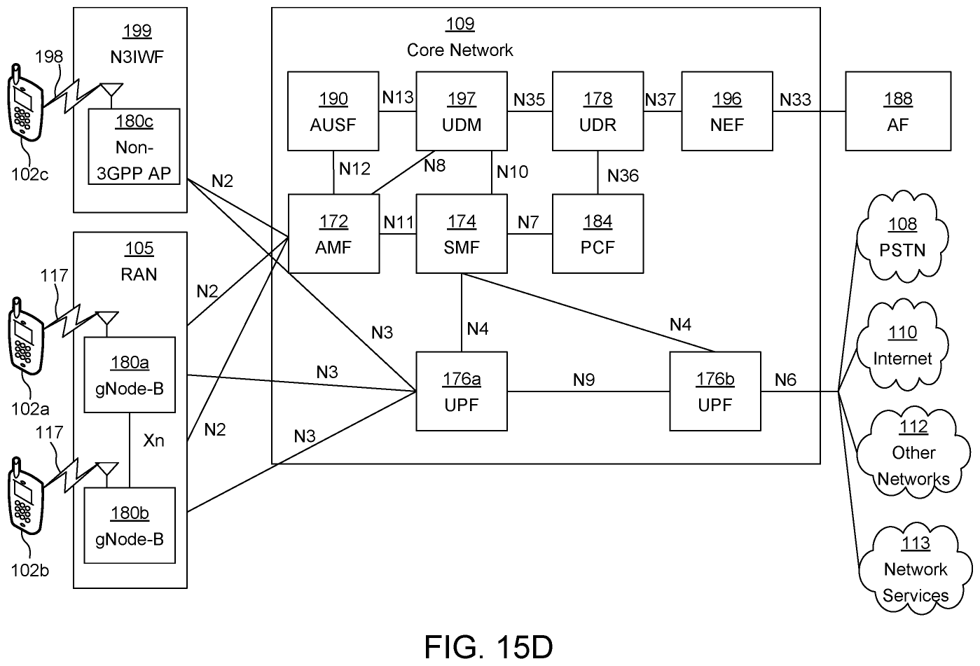

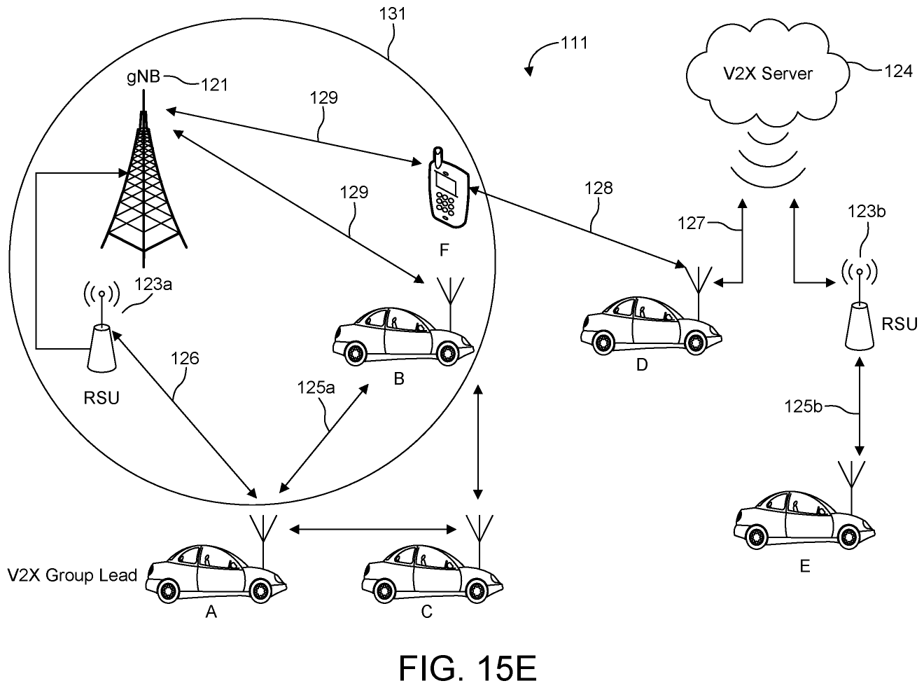

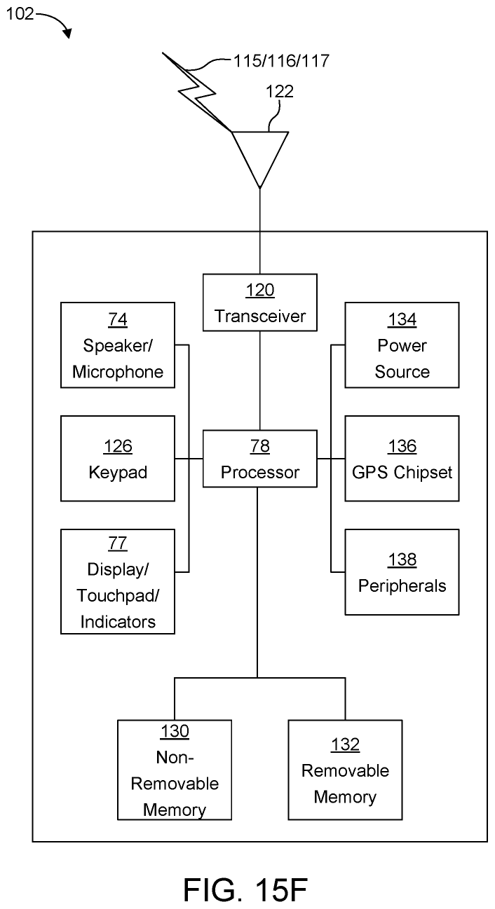

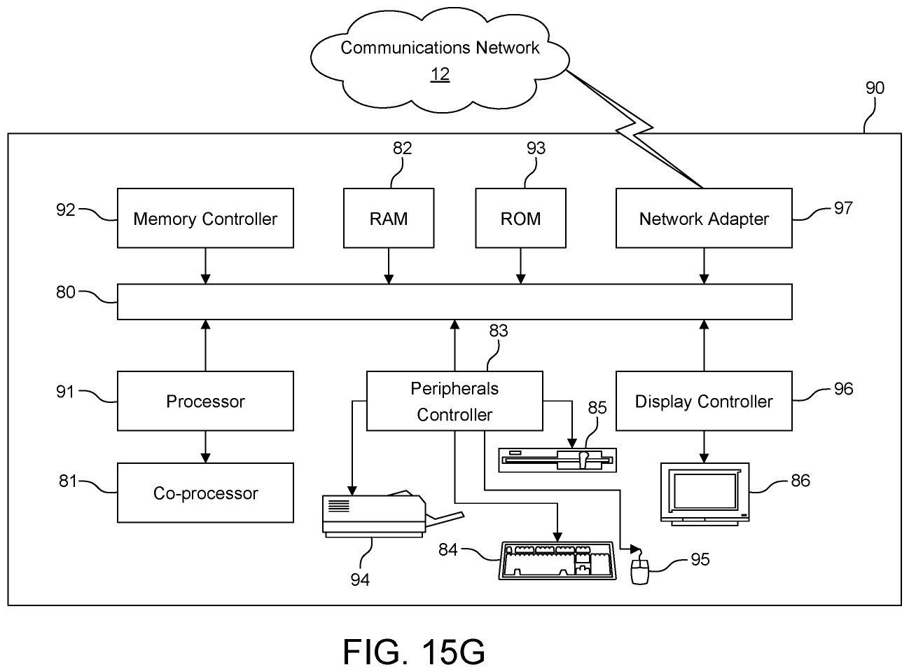

It is understood that the entities performing the steps illustrated herein, such as FIG. 3-FIG. 13, may be logical entities. The steps may be stored in a memory of, and executing on a processor of, a device, server, or computer system such as those illustrated in FIG. 15F or FIG. 15G. Skipping steps, combining steps, or adding steps between exemplary methods disclosed herein (e.g., FIG. 3-FIG. 13) is contemplated. Table 4 includes abbreviations and definitions. Table 5 includes terms and definitions.

TABLE 4
Abbreviations and Definitions

| Abbreviations | Definitions |
|---|---|
| 3GPP | The 3rd Generation Partnership Project |
| D-SH | Destination - Server Host |
| EAS | Edge Application Server |
| ECI | Edge Computing Infrastructure |
| EEC | Edge Enabler Client |
| EES | Edge Enabler Server |
| ECI-SH | Edge Computing Infrastructure- Server Host |
| ET-SH | Edge Terminal - Server Host |
| LDN | Local Data Network |
| LSA | Local Service Assistant |
| LS-C | Local Service - Client |
| LS-S | Local Service - Server |
| SCEF | Service Capability Exposure Function |
| SDS | Service Discovery Server |
| SH | Server Host |
| S-SH | Source-Server Host |
| UE | User Equipment |

TABLE 5
Terms and Definitions

| Terms | Definitions |
|---|---|
| 3GPP Network | Provides underlying network capabilities, e.g., |
| | provide location information, communication |
| | quality, traffic steering capability. |
| Configuration | A CS is a system-wide discovery and configuration |
| Server (CS) | server. The CS may facilitate a number of things, |
| | e.g., to enable ET-SHs 201 to discover available |
| | ECI-SHs, to enable SHs to discover nearby Local |
| | Service Assistant (LSA), etc. |
| Edge Computing | An ECI is a computing facility that is deployed at |
| Infrastructure (ECI) | the edge of the network, but not on a terminal, and |
| | that hosts edge services. For example, it may be |
| | deployed in the edge of the 5G network. |
| Edge Terminal (ET) | Endpoint devices that have sufficient |
| | computing/storage capabilities that enable them to |
| | host local edge services. Some examples include |
| | User Equipment (UE), road-side unit, vehicle, etc. |
| Local Service (LS) | A service deployed on an Edge Infrastructure or on |
| | an Edge Terminal but not in a centralized cloud. |
| Local Service | A Local Service Assistant (LSA) is an assistant |
| Assistant (LSA) | service that may support comprehensive LS |
| | management at the edge. For example, LSA may |
| | help various operations such as LS provisioning, LS |
| | registration, LS discovery, LS QoS management via |
| | relocation, etc. |
| Service Discovery | In order to support advanced discovery (across |
| Server (SDS) | cloud, edge and terminal), Service Discovery |
| | Servers (SDSs) may be deployed so that they may |
| | accept/process the service discovery requests from |
| | clients in order to identify desired services no matter |
| | the desired services are deployed in the central |
| | cloud, deployed at the edge computing |
| | infrastructure, or hosted by an edge terminal. |
| Server Host (SH) | SH may provide various local services by hosting |
| | corresponding LS-Severs. In particular, a LS-S may |
| | be originally provided or hosted by an ECI, such a |
| | SH is denoted as ECI-SH. Similarly, a LS-S could |
| | originally be provided or hosted by an Edge |
| | Terminal (such as an UE, a roadside unit, a vehicle, |
| | etc.), such a SH is denoted as a ET-SH. In addition, |
| | this disclosure may focus on relocation of LS-Ss. |
| | Terminology-wise, an LS relocation refers to |
| | relocating a specific LS-S instance from a Source |
| | SH (S-SH) to a Destination SH (D-SH). In |
| | particular, two cases are considered: |
| | In the first scenario as discussed herein, S- |
| | SH is ET-SH 201 and D-SH is an ECI-SH. |
| | In other words, a LS-S is originally hosted |
| | by an ET and the ET may leverage an ECI |
| | by relocating the LS-S to the ECI. |
| | In the second scenario as discussed herein, |
| | S-SH is an ECI-SH and D-SH is an ET-SH. |
| | In other words, a LS-S is originally hosted |
| | on a ECI and the ECI may leverage an ET by |
| | relocating the LS-S to the ET. |
| Local Service - | LS-C is a consumer of a particular LS-S and a LS-C |
| Client (LS-C) | needs to interact with LS-S in order to enjoy the |
| | corresponding LS. For example, a UE could host a |
| | LS-C. In particular, this disclosure considers the |
| | request-response service access module. In other |
| | words, an LS-C may send requests to a LS-S for |
| | accessing/consuming a particular LS. |
| Local Service - | An LS-Server provide server-side functionalities of |
| Server (LS-S) | the LS. |

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 15A illustrates an example communications system 100 in which the methods and apparatuses of assisting local service management on edge terminal devices, such as the systems and methods illustrated in FIG. 3 through FIG. 13 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 15A, FIG. 15B, FIG. 15C, FIG. 15D, FIG. 15E, or FIG. 15F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 15A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of assisting local service management on edge terminal devices, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 15A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of assisting local service management on edge terminal devices, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 15A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 15A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of assisting local service management on edge terminal devices, as disclosed herein. For example, the WTRU 102g shown in FIG. 15A may be configured to communicate with the base station 114a, which may employ a cellular-based radio technology, and with the base station 114c, which may employ an IEEE 802 radio technology.

Although not shown in FIG. 15A, it will be appreciated that a User Equipment may make a wired connection to a gateway. The gateway may be a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 15B is a system diagram of an example RAN 103 and core network 106 that may implement methods, systems, and devices of assisting local service management on edge terminal devices, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 15B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 15B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 15B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 15C is a system diagram of an example RAN 104 and core network 107 that may implement methods, systems, and devices of assisting local service management on edge terminal devices, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 15C, the eNode-Bs 160a, 160b, and 160c may communicate with one another over an X2 interface.

The core network 107 shown in FIG. 15C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 15D is a system diagram of an example RAN 105 and core network 109 that may implement methods, systems, and devices of assisting local service management on edge terminal devices, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 15D, the gNode-Bs 180a and 180b may communicate with one another over an Xn interface, for example.

The core network 109 shown in FIG. 15D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 15G.

In the example of FIG. 15D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 15D shows that network functions directly connect with one another, however, it should be appreciated that they may communicate via routing agents such as a diameter routing agent or message buses.

In the example of FIG. 15D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 15D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 15D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function may add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 15D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 15A, FIG. 15C, FIG. 15D, or FIG. 15E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 15A, FIG. 15B, FIG. 15C, FIG. 15D, or FIG. 15E are provided by way of example only, and it is understood that the subject matter disclosed and claimed herein may be embodied or implemented in any similar communication system, whether presently defined or defined in the future.

FIG. 15E illustrates an example communications system 111 in which the systems, methods, apparatuses that implement assisting local service management on edge terminal devices, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 15E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 15E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 15F is a block diagram of an example apparatus or device WTRU 102 that may be configured for wireless communications and operations in accordance with the systems, methods, and apparatuses that implement assisting local service management on edge terminal devices, described herein, such as a WTRU 102 of FIG. 15A, FIG. 15B, FIG. 15C, FIG. 15D, or FIG. 15E, or FIG. 3-FIG. 13). As shown in FIG. 15F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 15F and may be an exemplary implementation that performs the disclosed systems and methods for assisting local service management on edge terminal devices described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 15F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 15A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 15F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the assisting local service management on edge terminal devices in some of the examples described herein are successful or unsuccessful, or otherwise indicate a status of assisting local service management on edge terminal devices and associated components. The control lighting patterns, images, or colors on the display or indicators 77 may be reflective of the status of any of the method flows or components in the FIG.'s illustrated or discussed herein (e.g., FIG. 3-FIG. 14, etc.). Disclosed herein are messages and procedures of assisting local service management on edge terminal devices. The messages and procedures may be extended to provide interface/API for users to request resources via an input source (e.g., speaker/microphone 74, keypad 126, or display/touchpad/indicators 77) and request, configure, or query assisting local service management on edge terminal devices related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 15G is a block diagram of an exemplary computing system 90 in which one or more apparatuses of the communications networks illustrated in FIG. 15A, FIG. 15C, FIG. 15D and FIG. 15E as well as assisting local service management on edge terminal devices, such as the systems and methods illustrated in FIG. 3 through FIG. 13 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for assisting local service management on edge terminal devices, such as receiving or sending wired or wireless messages.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 15A, FIG. 15B, FIG. 15C, FIG. 15D, or FIG. 15E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure-assisting local service management on edge terminal devices—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for assisting local service management on edge terminal devices. A method, system, computer readable storage medium, or apparatus provides for receiving a provisioning request; processing the provisioning request, wherein the processing comprising finding available LSAs 202 or finding desired LSAs 202; and sending a response. The response may include an indication of an identification of one or more LSAs 202. A method, system, computer readable storage medium, or apparatus provides for sending a provisioning request; and in response to sending the provisioning request, receiving an indication of an identified LSA. A method, system, computer readable storage medium, or apparatus provides for managing various local services (LSs), and has a corresponding server host (SH) profile, wherein the SH profile is to describe the ET itself (as a server host); locally hosting/running a number of servers of Local Services, or denoted as Local Service-Servers (LS-Ss), wherein a LS-S has a corresponding LS-S profile that is to describe the information about a specific LS; sending a service provisioning request to a configuration server (CS) in order to discover available local service assistant (LSA) in a first area of interest; and receiving a response from the CS. the response may include the following information: the identified LSAs 202 or the access address (URI) or IP address of the identified LSAs 202. All combinations in this paragraph and the below paragraphs (including the removal or addition of steps) are contemplated in a manner that is consistent with the other portions of the detailed description.

A method, system, computer readable storage medium, or apparatus provides for hosting various Local Services (LSs), and have a corresponding Server Host (SH) profile, wherein the SH profile is to describe entity itself as a server host; identifying a desired LSA; sending a registration request to LSA 202, wherein the registration request may carry a SH profile of the server host or a list of LS-S profiles; and receiving a response from the desired LSA, wherein the following information may be included: the registration result; the assigned D-SH(s) that may serve the future relocation needs for the server host, etc. A method, system, computer readable storage medium, or apparatus provides for receiving a registration request from a first Server Host (SH); conducting local service management operations for facilitating the LSs hosted by the first SH; and sending a response to the first SH, wherein the information comprises the registration result. A method, system, computer readable storage medium, or apparatus provides for receiving a local service discovery request from a first local service client (denoted as a LS-C); checking SH profile and LS-S profiles stored in the local directory and find out (e.g., determine) which local services are of interest to the first local service client; and sending a local service discovery result to the first local service client. A method, system, computer readable storage medium, or apparatus provides for sending a local service advertisement request to ask 3GPP network to advertise its available local services to the potential local service clients; based on the availability of a local service X and its corresponding server host, requesting the 3GPP network to broadcast a local service availability advertainments to certain geographical areas in which the potential local service clients could access the local service X; and receiving a confirmation from the 3GPP network that a local service availability broadcast has been disseminated to all the potential clients.

A method, system, computer readable storage medium, or apparatus provides for locally hosting a first instance of a Local Service Server (LS-S); receiving, requests to configure one or more policies for relocating the local service server in order to meet certain QoS objectives; receiving, local service access requests from Local Service Clients (LS-Cs) that target the first instance of LS-S; detecting that a trigger condition, defined by a policy, is met for initiating the relocation of the first instance of LS-S to a second LS server host (e.g., an ECI server host); sending a service relocation request to a network entity (e.g., LSA 202) for the first local service server to be relocated; receiving, a response indicating that future LS access requests targeting the first local service server will be redirected to the second local service server, which is instantiated on the second LS server host; detecting that a trigger condition, defined by a policy, is met to stop redirecting the access requests to the second LS server; sending a request to a network entity to stop redirecting incoming requests targeting the first local service server to the second local service server; receiving a response indicating that request redirecting is stopped; and receiving a response indicating that the second local service server instantiated on the second LS server host has been successfully terminated. All combinations in this and the below paragraph (including the removal or addition of steps) are contemplated in a manner that is consistent with the other portions of the detailed description.

The disclosed subject matter may target edge terminal service host that hosts a local service and then initiates relocating this local service to another service host in the system when it detects that the local service has become overloaded. A method, system, computer readable storage medium, or apparatus provides for receiving requests, from one or more local service clients, to access a local service hosted by an edge terminal-service host (ET-SH); based on the requests, determining that the local service has reached a threshold overload condition; detecting that the threshold overload condition meets one or more service relocation trigger conditions; based on the threshold overload condition meeting the one or more service relocation trigger conditions, sending a service relocation request, wherein the service relocation request is for: indicating to a local service assistant to relocate the local service to another service host, or notifying the one or more local service clients of relocation of the local service to the another service host; and receiving a confirmation from the local service assistant that the request to relocate the local service is complete. The apparatus comprises a wireless transmit/receive unit (WTRU). The one or more local service clients are hosted on wireless transmit/receive units (WTRUs) different than a WTRU hosting the ET-SH and local service. A method, system, computer readable storage medium, or apparatus provides for determining the local service has reached a threshold overloaded condition comprises detecting that a rate of the requests for the local service has reached a first threshold. A method, system, computer readable storage medium, or apparatus provides for detecting that the threshold overload condition meets one or more service relocation trigger conditions comprises checking one or more conditions defined in a relocation policy for the local service have bene met.

1. An apparatus comprising:
a processor; and
memory coupled with the processor, the memory comprising executable instructions stored thereon that when executed by the processor cause the processor to effectuate operations comprising:
receiving requests, from one or more local service clients, to access a local service hosted by an edge terminal-service host (ET-SH);
based on the requests, determining that the local service has reached a threshold overload condition;
detecting that the threshold overload condition meets one or more service relocation trigger conditions;
based on the threshold overload condition meeting the one or more service relocation trigger conditions, sending a service relocation request, wherein the service relocation request is for:
indicating to a local service assistant to relocate the local service to another service host, or
notifying the one or more local service clients of relocation of the local service to the another service host; and
receiving a confirmation from the local service assistant that the request to relocate the local service is complete.

2. The apparatus of claim 1, wherein the apparatus comprises a wireless transmit/receive unit (WTRU).

3. The apparatus of claim 1, wherein the one or more local service clients are hosted on wireless transmit/receive units (WTRUs) different than a WTRU hosting the ET-SH and local service.

4. The apparatus of claim 1, wherein the determining the local service has reached a threshold overloaded condition comprises detecting that a rate of the requests for the local service has reached a first threshold.

5. The apparatus of claim 1, wherein the determining the local service has reached a threshold overloaded condition comprises detecting a processing time of the requests by the local service has reached a first threshold.

6. The apparatus of claim 1, wherein the determining the local service has reached a threshold overloaded condition comprises detecting that an amount of energy of the ET-SH has reached a first threshold.

7. The apparatus of claim 1, wherein the detecting that the threshold overload condition meets one or more service relocation trigger conditions comprises checking one or more conditions defined in a relocation policy for the local service have been bene-met.

8. The apparatus of claim 1, wherein the apparatus is the ET-SH.

9. A method comprising:
receiving requests, from one or more local service clients, to access a local service hosted by an edge terminal-service host (ET-SH);
based on the requests, determining that the local service has reached a threshold overload condition;
detecting that the threshold overload condition meets one or more service relocation trigger conditions;
based on the threshold overload condition meeting the one or more service relocation trigger conditions, sending a service relocation request, wherein the service relocation request is for:
indicating to a local service assistant to relocate the local service to another service host, or
notifying the one or more local service clients of relocation of the local service to the another service host; and
receiving a confirmation from the local service assistant that the request to relocate the local service is complete.

10. The method of claim 9, wherein the ET-SH comprises a wireless transmit/receive unit (WTRU).

11. The method of claim 9, wherein the one or more local service clients are hosted on wireless transmit/receive units (WTRUs) different than a WTRU hosting the ET-SH and local service.

12. The method of claim 9, wherein the determining the local service has reached a threshold overloaded condition comprises detecting that a rate of the requests for the local service has reached a first threshold.

13. The method of claim 9, wherein the determining the local service has reached a threshold overloaded condition comprises detecting a processing time of the requests by the local service has reached a first threshold.

14. The method of claim 9, wherein the determining the local service has reached a threshold overloaded condition comprises detecting that an amount of energy of the ET-SH has reached a first threshold.

15. The method of claim 9, wherein the detecting that the threshold overload condition meets one or more service relocation trigger conditions comprises checking one or more conditions defined in a relocation policy for the local service have been bene-met.

16. A computer readable storage medium storing computer executable instructions that when executed by a computing device cause the computing device to effectuate operations comprising:
receiving requests, from one or more local service clients, to access a local service hosted by an edge terminal-service host (ET-SH);
based on the requests, determining that the local service has reached a threshold overload condition;
detecting that the threshold overload condition meets one or more service relocation trigger conditions;
based on the threshold overload condition meeting the one or more service relocation trigger conditions, sending a service relocation request, wherein the service relocation request is for:
indicating to a local service assistant to relocate the local service to another service host, or
notifying the one or more local service clients of relocation of the local service to the another service host; and
receiving a confirmation from the local service assistant that the request to relocate the local service is complete.

17. The computer readable storage medium of claim 16, wherein the apparatus comprises a wireless transmit/receive unit (WTRU).

18. The computer readable storage medium of claim 16, wherein the one or more local service clients are hosted on wireless transmit/receive units (WTRUs) different than a WTRU hosting the ET-SH and local service.

19. The computer readable storage medium of claim 16, wherein the determining the local service has reached a threshold overloaded condition comprises detecting that a rate of the requests for the local service has reached a first threshold.

20. The computer readable storage medium of claim 16, wherein the determining the local service has reached a threshold overloaded condition comprises detecting that an amount of energy of the ET-SH has reached a first threshold.
